(19) United States
(12) Patent Application Publication
(10) Pub. No.: US 2026/0264180 A1
(43) Pub. Date: Sep. 10, 2026

(54) MACHINE AND PROCESS FOR SHAPING A BALL STUD AND A BALL STUD PRODUCED BY SAME

(71) Applicant: Federal Screw Works, Romulus, MI (US)

(72) Inventors: Aaron J. ZurSchmiede, East Grand Rapids, MI (US); David A. Bartell, Big Rapids, MI (US); Christian Shane Bersano, Stanwood, MI (US)

(73) Assignee: Federal Screw Works, Romulus, MI (US)

(21) Appl. No.: 19/559,095

(22) Filed: Mar. 6, 2026

Related U.S. Application Data
(60) Provisional application No. 63/769,254, filed on Mar. 10, 2025.
(60) Provisional application No. 63/769,255, filed on Mar. 10, 2025.

(51) Int. Cl. B23P 13/02; B24B 39/04

(52) U.S. Cl. CPC B23P 13/02; B24B 39/04; B23P 2700/11

(57) ABSTRACT

A machine assembly for shaping a ball stud. The machine includes a shaping workstation that has at least one shaping tool for removing material from and shaping a preform. A finish workstation includes a finish spindle configured to couple to and rotate the preform about a finish axis of rotation relative to a finish cutting module and a burnishing module. The finish cutting module includes a finish cutting tool and an actuator configured to move an edge of the finish cutting tool into engagement with a ball of the preform. The burnishing module includes a hydrostatic quill configured to contact and burnish an exterior surface of the ball.

### CROSS-REFERENCE TO RELATED APPLICATIONS

This application claims priority to and the benefit under 35 U.S.C. § 119(e) of U.S. Provisional Application No. 63/769,254, filed on Mar. 10, 2025, entitled “MACHINE AND PROCESS FOR SHAPING A BALL STUD AND A BALL STUD PRODUCED BY SAME,” and the benefit under 35 U.S.C. § 119(e) of U.S. Provisional Application No. 63/769,255, filed on Mar. 10, 2025, entitled “BALL STUD AND A BALL STUD JOINT,” the disclosures of which are hereby incorporated herein by reference in its entirety.

### FIELD OF THE DISCLOSURE

The present disclosure generally relates to a machine assembly and process for shaping a ball stud from a ball stud preform and a ball stud produced by the same.

### BACKGROUND OF THE DISCLOSURE

Ball stud joints are utilized in several industries and are generally known as the ball portion and shaft of a joint under common industrial terms like ball-and-socket joints, hip joints, and a variety of other terms. Generally speaking, the ball stud includes a spherical or semi-spherical head that is seated within a socket and provides multi-directional movement and rotation relative to the socket. While the disclosure is not limited thereto, common uses of ball studs are found in automotive components, robotics, and any other application wherein a multi-directional joint can be utilized. One common automotive component that utilizes the ball stud is a suspension system, where the ball stud is seated within a socket and pairs a control arm to a steering knuckle.

Depending on how the ball stud is utilized, external loads from joined components, repeated multi-directional movement, and exposure to environmental conditions can limit operational life. As the ball stud becomes degraded over time, the multi-directional movement can become arduous and relative movements in some directions may be more difficult than relative movements in other directions. This degradation can negatively impact operations of joined components via increased force or load requirements internal to the ball stud and socket coupling. Different characteristics of the ball stud and, more particularly, the spherical or semi-spherical head, can influence operational life. Some of the most important characteristics for extending operational life and continued desired multi-directional movement between the joined components include material properties and surface roughness. More particularly, while considering the ideal material properties factors, such as materials used (e.g., hardness, workability, availability, and other qualities), microstructures and internal forces within that material (e.g., based on the machine assembly and process) can be optimized for prolonged operational life and protection against the factors that can lead to degradation. In addition, a reduction in surface roughness of the spherical or semi-spherical head can also lead to prolonged operational life and improved operation as, the smoother the surface is, the less external forces can negatively impact the multi-directional movement.

In view of the above, the present disclosure generally provides for a machine assembly, process, and a ball stud produced by the same with improvements in both material properties and surface roughness. Further, the machine assembly utilizes components and processes that provide a scalable system for efficient mass production.

### SUMMARY OF THE DISCLOSURE

According to one aspect of the present disclosure, a machine assembly for shaping a ball stud. The machine includes a shaping workstation that has at least one shaping tool for removing material from and shaping a preform. A finish workstation includes a finish spindle configured to couple to and rotate the preform about a finish axis of rotation relative to a finish cutting module and a burnishing module. The finish cutting module includes a finish cutting tool and an actuator configured to move an edge of the finish cutting tool into engagement with a ball of the preform. The burnishing module includes a hydrostatic quill configured to contact and burnish an exterior surface of the ball.

According to another aspect of the present disclosure, a machine assembly that forms a ball stud includes a finish spindle configured to couple to and rotate the preform about a finish axis of rotation, a finish cutting module, and a burnishing module. The finish cutting module includes a first rotational drive that rotates the finish cutting tool in a first rotational direction with respect to a ball of the preform. The burnishing module includes a second rotational drive that rotates a low plasticity burnishing quill in a second rotational direction with respect to the ball that is opposite the first rotational direction.

According to yet another aspect of the present disclosure, a machine assembly for shaping a ball stud includes at least one arm configured load the preform into a workstation. The workstation includes a shaping workstation having at least two shaping tools selectively movable for simultaneous engagement with and removal of material from the preform. The machine assembly further includes a finish workstation having a finish cutting tool and a hydrostatic quill that is configured to follow surfaces of a ball of the preform that have already been engaged by the finish cutting tool.

According to still another aspect of the disclosure, a process of shaping a ball stud includes shaping a preform at a shaping station, transferring the preform to a finish station, and rotating the preform about a finish axis of rotation. A finish cutting tool is rotated in a first rotational direction with respect to a ball of the preform, and a hydrostatic quill is rotated in a second rotational direction with respect to the ball that is opposite the first rotational direction.

According to another aspect of the present disclosure, a ball stud includes a stud portion defining an outer stud portion surface and a ball with an outer shell defining an outer shell surface. The outer shell surface exhibits a surface roughness that is less than 25% of the outer stud portion surface.

According to yet another aspect of the present disclosure, a ball stud joint includes a first component defining a socket and a second component coupled to a ball stud. The ball stud includes a stud portion and a ball seated within the socket. The ball has an outer shell defining an outer shell surface with a surface roughness less than 0.08 Ra.

According to still yet another aspect of the disclosure, a ball stud includes a stud portion formed of a first material and a ball formed of the first material and extending from the stud portion. An outer shell surrounds at least part of a surface of the ball, the outer shell formed of a second material with greater internal residual stress than the first material.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a schematic view of a machine assembly of a first arrangement utilized in shaping a ball stud in accordance with an aspect of the present disclosure;

FIG. 2A is a top front perspective view of a machine assembly of a first arrangement utilized in shaping a ball stud in accordance with an aspect of the present disclosure;

FIG. 2B is a top rear perspective view of a machine assembly of a first arrangement utilized in shaping a ball stud in accordance with an aspect of the present disclosure;

FIG. 3 is a top perspective view of a first workstation in a machine assembly of a first arrangement that is utilized for initially machining a ball stud preform in accordance with an aspect of the present disclosure;

FIG. 4A is a top perspective view of a second workstation in a machine assembly of a first arrangement that is utilized for finishing a ball stud preform into a ball stud that includes a burnishing component that modifies a microstructure around a spherical or semi-spherical head of the ball joint stud in accordance with an aspect of the present disclosure;

FIG. 4B is a side view of a second workstation in a machine assembly of a first arrangement that is utilized for finishing a ball stud preform into a ball stud that includes a burnishing component that modifies a microstructure around a spherical or semi-spherical head of the ball joint stud in accordance with an aspect of the present disclosure;

FIG. 5 is a schematic view of a machine assembly of a second arrangement utilized in shaping a ball stud in accordance with an aspect of the present disclosure;

FIG. 6 is a top front perspective view of a machine assembly of a second arrangement utilized in shaping a ball stud in accordance with an aspect of the present disclosure;

FIG. 7 is a top perspective view of a first workstation in a machine assembly of a second arrangement that is utilized for initially machining a ball stud preform in accordance with an aspect of the present disclosure;

FIG. 8A is a top perspective view of a second workstation in a machine assembly of a second arrangement that is utilized for finishing a ball stud preform into a ball stud that includes a burnishing component that modifies a microstructure around a spherical or semi-spherical head of the ball joint stud in accordance with an aspect of the present disclosure;

FIG. 8B is a side view of a burnishing component of a machine assembly of a second arrangement in a first position, the burnishing component is configured to modify a microstructure around a spherical or semi-spherical head of the ball joint stud in accordance with an aspect of the present disclosure;

FIG. 8C is a side view of a burnishing component of a machine assembly of a second arrangement in a second position, the burnishing component is configured to modify a microstructure around a spherical or semi-spherical head of the ball joint stud in accordance with an aspect of the present disclosure;

FIG. 9 is a schematic view of a control system that operates different workstations of a machine assembly of any arrangement in accordance with an aspect of the present disclosure;

FIG. 10 is a process flow chart that illustrates different process steps in shaping a ball stud in accordance with an aspect of the present disclosure;

FIG. 11 is a top perspective view of a ball stud that may be produced by a machine assembly and process in accordance with an aspect of the present disclosure;

FIG. 12 is a cross-sectional view of a ball stud in accordance with an aspect of the present disclosure;

FIG. 13 is a cross-sectional view of a ball joint coupling a first component to a second component in accordance with an aspect of the present disclosure;

FIG. 14A is a perspective view of a vehicle suspension system incorporating the ball joint in accordance with an aspect of the present disclosure; and

FIG. 14B is a perspective view of a robotic incorporating the ball joint in accordance with an aspect of the present disclosure.

### DETAILED DESCRIPTION

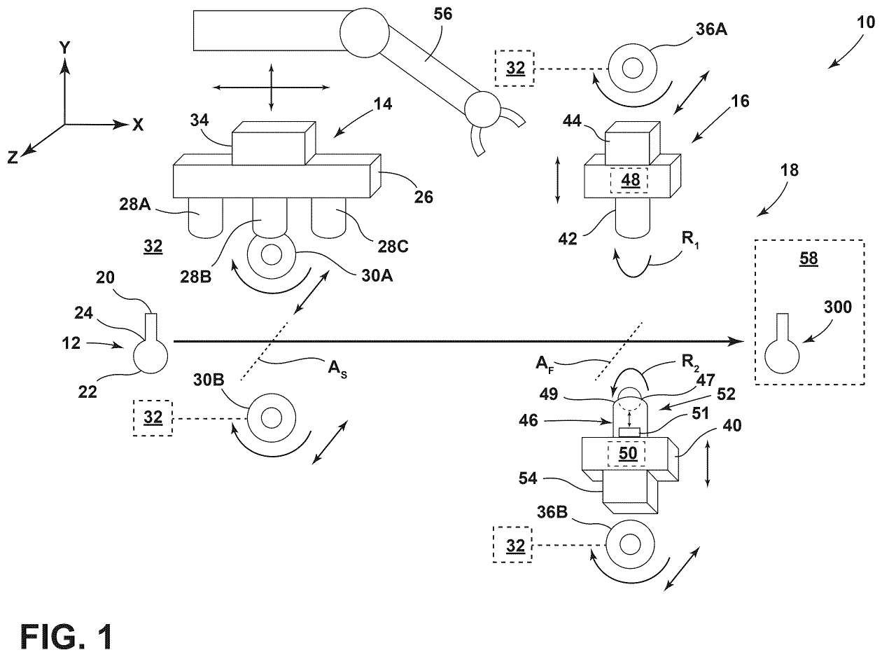

For purposes of description herein, the terms “upper,” “lower,” “right,” “left,” “rear,” “front,” “vertical,” “horizontal,” and derivatives thereof shall relate to the concepts as oriented in FIG. 1, and, more particularly, within the context of a manufacturing environment. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a machine assembly and process for shaping a ball stud from a ball stud preform and a ball stud produced by same. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a component is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

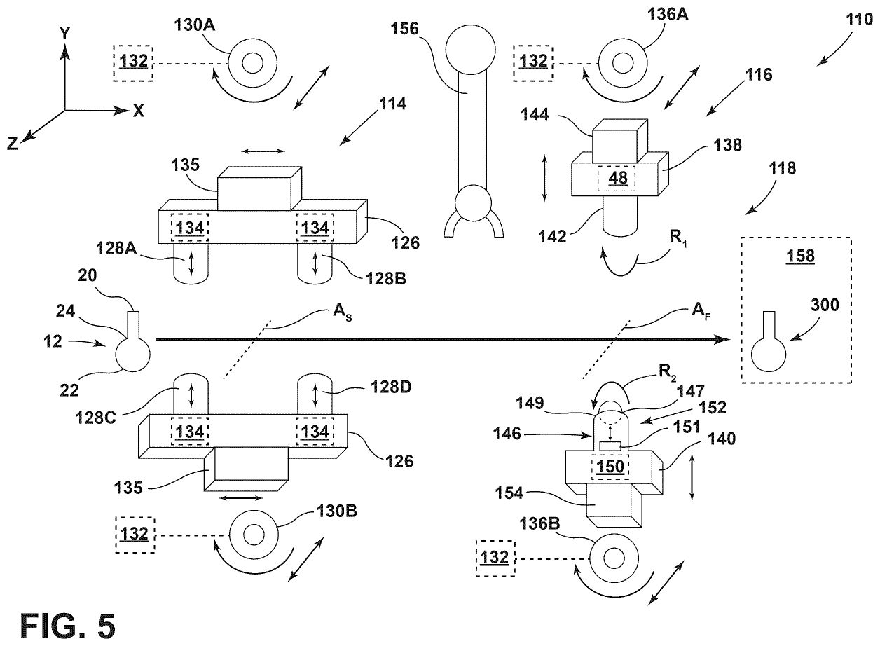

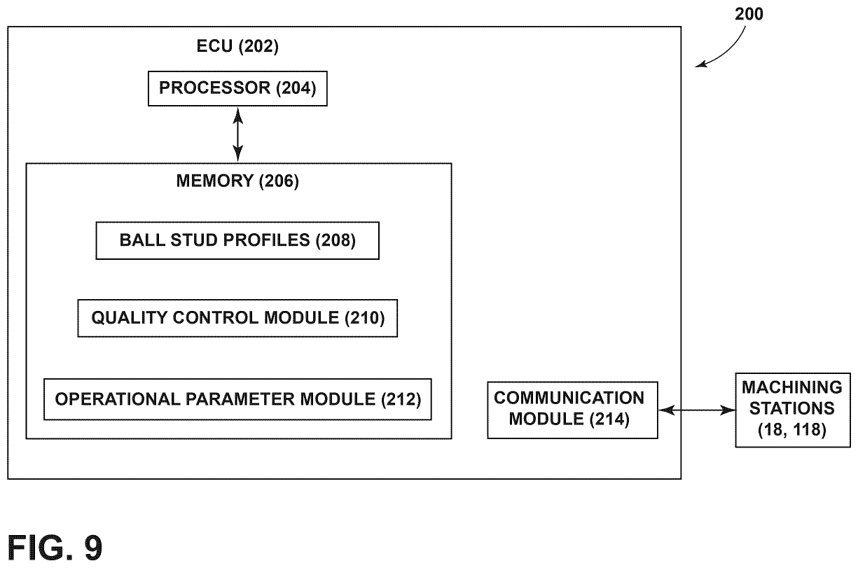

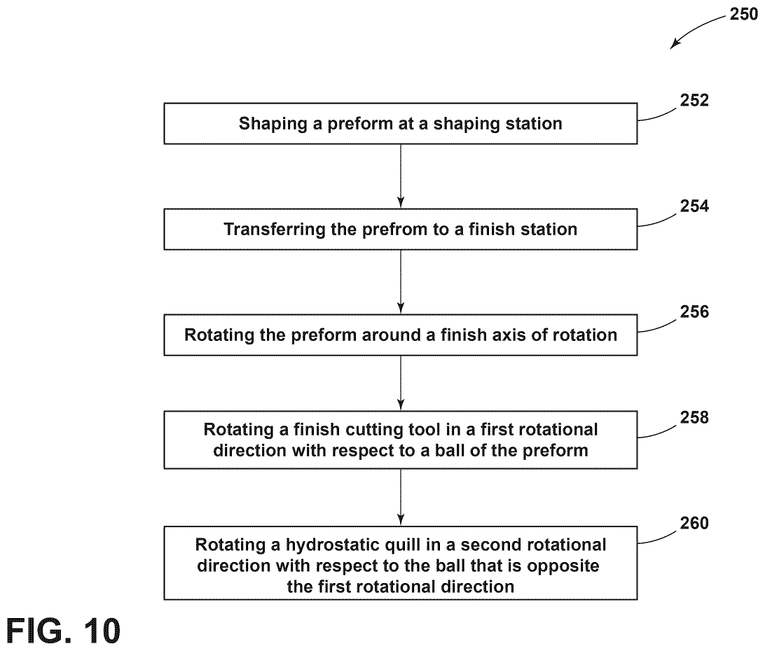

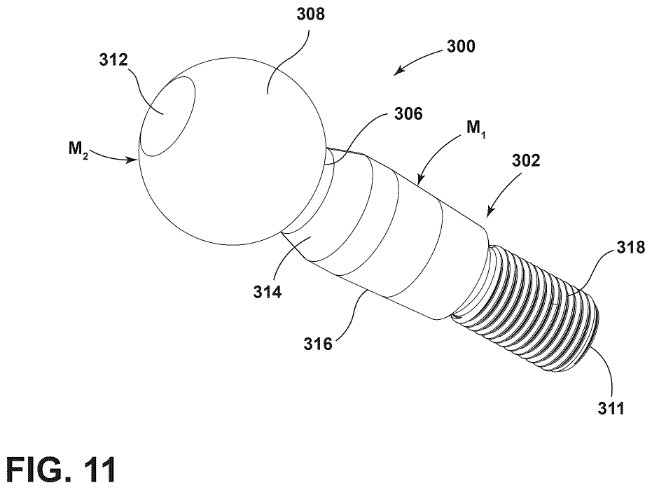

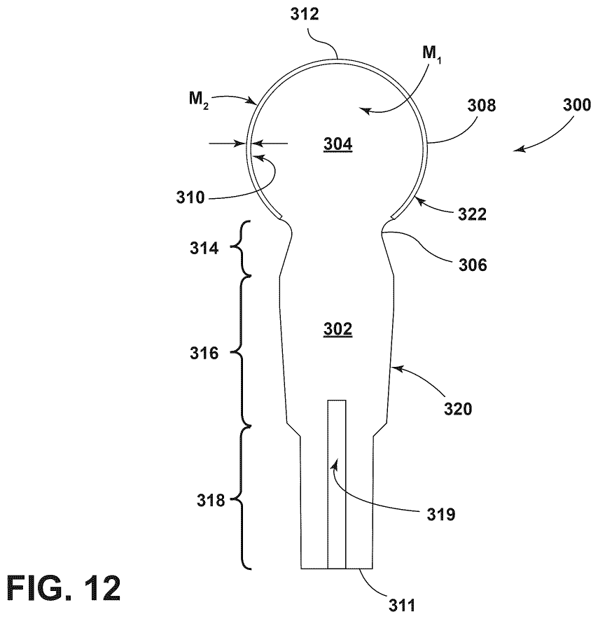

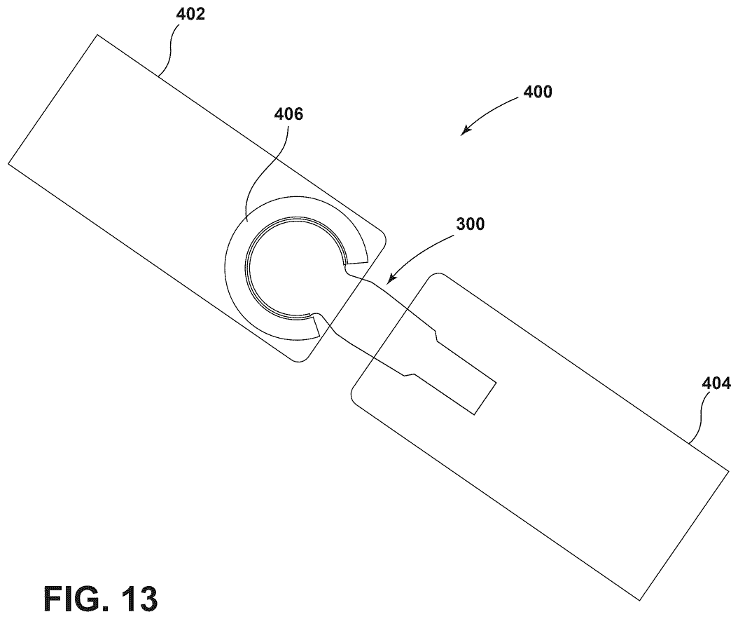

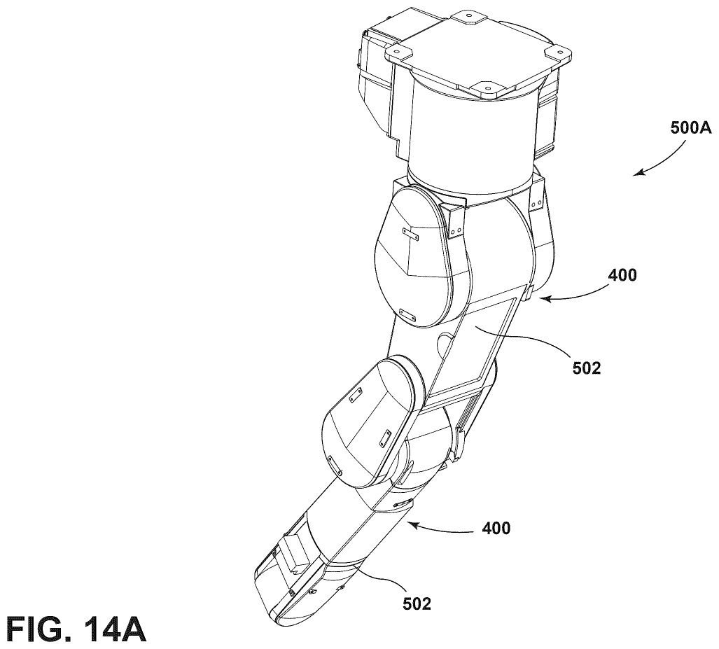

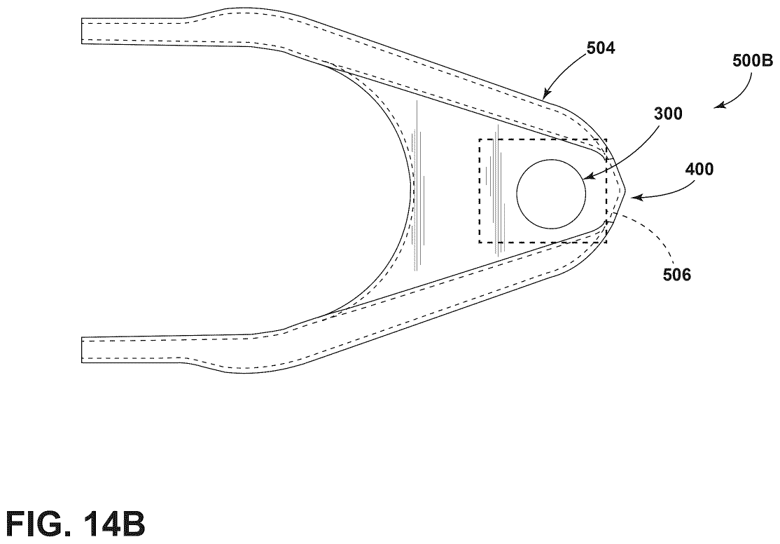

The present application is generally directed to one, more, or a combination of a machine assembly 10 of a first arrangement (FIGS. 1-4B), a machine assembly 110 of a second arrangement (FIGS. 5-8C), a control system 200 (FIG. 9) that operates the machine assembly 10, 110, a method or process 250 (FIG. 10) implemented by both the machine assembly 10, 110 and control system 200, an article or, more particularly, a ball stud 300 (FIGS. 11 and 12), a ball stud joint 400 incorporating same (FIG. 13), and structures 500A, 500B (FIGS. 14A and 14B) incorporating the ball stud joint 400. The machine assembly 10, 110 includes several components that, via instructions from the control system 200, implement the process 250 for machining, turning, and/or otherwise shaping the ball stud 300. As will be detailed in the proceeding paragraphs, the machine assembly 10, 110 and, by extension, the process 250 are both efficient in operation and scalable for mass production. As a result of the components of the machine assembly 10, 110 and the process 250, the created ball stud 300 exhibits one or more benefits in material properties and/or surface roughness for improving performance and prolonging operational life.

With reference initially to FIG. 1, a schematic illustration of the machine assembly 10 is depicted in accordance with a first arrangement. In the first arrangement, the machine assembly 10 receives a ball stud preform 12 and delivers the ball stud 300. It should be appreciated that the ball stud 300 that is delivered by the machine assembly 10 may or may not require additional processes prior to incorporation into an end application and use. Further, it should be appreciated that, as used herein, the term “ball stud preform” or “preform” may refer to the part prior to undergoing each of the processes as described herein. In the depicted illustration, the machine assembly 10 includes a shaping workstation 14 and a finish workstation 16, which together may define a machining station 18 that receives one of the ball stud preforms 12 and delivers one of the ball studs 300. While the machine assembly 10 is only depicted as including a single machining station 18, it should be appreciated that the machine assembly 10 may be scaled to include two, three, four, or more machining stations 18 that each form ball studs 300 in parallel or sequence. In the depicted arrangement in FIG. 1, the process 250 moves from left to right or along a designated X-axis. Different components of the machine assembly 10 will be described as moving or rotating relative to the X-axis, a designated Y-axis which may also be referred to as a vertical direction, and/or a designated Z-axis which projects from or away from the drawing depicted in FIG. 1. The preform 12 may generally include a stud portion 20 that extends to a head or ball 22. A collar portion 24 (e.g., or “undercut”) may be spaced between the stud portion 20 and the ball 22. As will be described in greater detail below, the workstations 14, 16 may modify the shape and/or material of the preform.

The shaping workstations 14 may have a shaping module 26 that is coupled to at least one shaping tool 28A-28C for removing material from and shaping the preform 12. More particularly, cutting tools, lathes, threaders, grinders, and/or the like may be utilized for shaping, roughening (e.g., performing the rough turning on) different portions of the preform 12. In some implementations, the shaping module 26 may further include finishing tools, such as a finish cutting tool and/or a burnishing quill that will be described in further detail below. In some implementations, the at least one shaping tool 28A-28C may be configured to, for example, taper or shape the stud portion 20 and/or the collar portion 24 (e.g., the undercut), shape the ball 22, add threading to the stud portion 20, and/or the like. In some implementations, the at least one shaping tool 28A-28C may include more than one shaping tool 28A-28C. For example, the at least one shaping tool 28A-28C may include at least a first shaping tool 28A, a second shaping tool 28B, and a third shaping tool 28C. However, it should be appreciated that the at least one shaping tool 28A-28C may be more or less shaping tools 28A-28C than those depicted. Each of the shaping tools 28A-28C depicted in FIG. 1 may be uniquely configured to perform a different task on the preform 12 (e.g., shaping, adding threads, tapers, and/or the like) including those functionalities listed above.

In operation, the preform 12 is loaded into a shaping spindle 30A, 30B that includes a first shaping spindle body 30A and a second shaping spindle body 30B. More particularly, at least one of the first shaping spindle body 30A and the second shaping spindle body 30B may move towards and away from each other along the Z-axis. In some implementations, both the first shaping spindle body 30A and the second shaping spindle body 30B may move towards and away from each other along the Z-axis as indicated by arrows. The shaping spindle bodies 30A, 30B clamp different surfaces of the preform 12 (e.g., the stud portion 20, the ball 22, and/or the collar 24) and both rotate, as indicated by rotational arrows, in concert to rotate the preform 12 along a shaping axis of rotation Aₛ. The shaping axis of rotation Aₛ may be aligned and parallel with the Z-axis and generally centers and movement of the shaping spindle bodies 30A, 30B.

The shaping module 26 may be affixed to each of the shaping tools 28A-28C and movable transverse (e.g., perpendicular) to the shaping axis of rotation Aₛ and, more particularly, along the Y-axis (e.g., vertically) to bring one or more of the shaping tools 28A-28C into contact with the rotating preform. During the engagement between the one or more shaping tools 28A-28C and the preform, at least one of the shaping spindle bodies 30A, 30B and the shaping module 26 may be movable along the Z-axis to align the one or more shaping tools 28A-28C with different surfaces of the preform 12. In the depicted arrangement, the shaping spindle bodies 30A, 30B move the preform 12 along the shaping axis of rotation Aₛ during the shaping process. More particularly, one or more spindle actuators 32 may be configured to move the shaping spindle bodies 30A, 30B linearly (e.g., along the shaping axis of rotation Aₛ) and rotationally (e.g., about the shaping axis of rotation Aₛ).

The shaping module 26, on the other hand, may include one or more shaping module actuators 34 for selectively moving the one or more shaping tools 28A-28C into engagement with the preform 12 and dictating the depth of material removal and dimensions of the preform after and/or during the shaping process. The movement of the shaping tools 28A-28C into and out of engagement with the preform 12 may be along the vertical or Y-axis, along the horizontal or X-axis, and/or along the length of the preform 12 in the Z-axis. Movement along the Y and X axes may be utilized to define a depth, while movement along the Z-axis may define a location along the preform 12 that is being machined. In some implementations, the shaping module 26, via the shaping module actuators 34, may be movable transverse (e.g., along the X-axis) to the shaping axis of rotation Aₛ in order to selectively bring some (e.g., one) but not all of the shaping tools 28A-28C into contact with the preform 12. In this manner, the shaping module 26 may be configured to permit several different machining/shaping steps to be completed in the shaping workstation 14. The shaping tools 28A-28C may therefore be referred to as a collection of shaping tools or gang tools that can be individually moved via the shaping module 26 into and out of engagement with the preform 12.

In operation, while the preform 12 is rotated, the shaping module actuators 34 can move the shaping module 26 and, by extension, one of the shaping tools 28A-28C into and out of engagement with the preform 12 along the vertical or Y-axis. When a new shaping tool 28A-28C is needed, the shaping module actuators 34 can move the currently engaged shaping tool 28A-28C away from the preform 12 and then move the shaping tools 28A-28C along the X-axis until a different shaping tool 28A-28C is aligned with the preform 12. Once the different shaping tool 28A-28C is aligned with the preform 12, the shaping module actuators 34 can be adjusted along the Y-axis for reengagement. The shaping spindle bodies 30A, 30B may continue to rotate the preform 12 throughout the entire shaping process as different ones of the shaping tools 28A-28C are selected and utilized.

The shaping spindle bodies 30A, 30B may rotate between about 2,000 to about 7,000 RPMs. For example, the shaping spindle bodies 30A, 30B may rotate between about 3,000 to about 7,000 RPMs, between about 4,000 to about 7,000 RPMs, between about 5,000 to about 7,000 RPMs, or between about 5,000 to about 6,000 RPMs. The shaping module actuators 34 may be configured to adjust (e.g., along the Y-axis) a depth of material removal in a nano or micron scale. In this manner, the conjoint movement between the shaping spindle bodies 30A, 30B and the shaping module 26 and/or shaping tool 28A-28C can accurately and consistently complete the shaping process efficiently once the preform 12 is received, for example, between 4 seconds and 12 seconds, between 4 seconds and 11 seconds, within 10 seconds or less, within 8 seconds, within 6 seconds or less, within 5 seconds or less, within 4 seconds or less, within 3 seconds or less, or within 2 seconds or less. In some implementations, the idling time (e.g., the time it takes to transfer subsequent preforms 12 to and from the shaping workstation 14) can be about 6 seconds. Further, as detailed above, each machining station 18 can be scaled to shape multiple preforms simultaneously within the above timeframes, depending on the number of available machining stations 18.

After the shaping steps have been completed in the shaping workstation 14, the preform 12 may be transferred (e.g., along the X-axis) to the finish workstation 16. It should be appreciated that while designated the “finish station,” the preform 12 may nonetheless undergo additional shaping in the finish workstation 16 and/or finishing steps after the finish workstation 16. More particularly, the finish station 16 may include a finish spindle 36A, 36B configured to couple and rotate (e.g., via spindle actuators 32) the preform 12 about a finish axis of rotation A_{F} relative to a finish cutting module 38 (e.g., a finish turning module) and a burnishing module 40. The finish cutting module 38 may include a finish cutting tool 42 and a finish cutting actuator 44 configured to move an edge of the finish cutting tool 42 into engagement with the ball 22 of the preform 12 (e.g., along the X-axis or the Y-axis). The burnishing module 40 may include a burnishing quill 46 configured to contact and burnish an exterior surface of the ball 22. While the burnishing module 40 and the burnishing quill 46 (i.e., and associated components) are depicted as being lower along the vertical axis Y than the finish cutting module 38, the finish cutting tool 42 (e.g., and associated components), the locations of both may be switched. For example, the burnishing module 40 and the burnishing quill 46 (i.e., and associated components) may be higher along the vertical axis Y than the finish cutting module 38, the finish cutting tool 42 (e.g., and associated components).

The burnishing quill 46 may be configured as a low plasticity burnishing quill or, more specifically, a hydrostatic quill. The burnishing quill 46 induces a layer with internal residual stress within the ball 22. Under the principles of burnishing and, more particularly, hydrostatic burnishing, the burnishing quill 46 may include a shape (e.g., a bearing 47 having a spherical shape) that is hydrostatically held within a holder (e.g., an outer sleeve 49). The bearing 47 may effectively float within the sleeve 49 to prevent metal-on-metal contact. The bearing 47 is pressed onto a surface of a workpiece (e.g., a surface of the ball 22) and the friction and forces between the bearing 47 and the ball 22 plastically deform and smooth the ball 22 while changing the microstructure of an outer layer of the ball that exhibits improved fatigue strength. As will be described in greater detail below, the friction and forces via the burnishing process may include a pressure medium 51, such as a liquid, oil, or air that can be located between the bearing 47 and sleeve 49 to facilitate the floating of the bearing 47 and vibrationally dampen the burnishing process. In this manner, the burnishing quill both improves the smoothness of the ball 22 and creates a layer with a microstructure that exhibits internal residual stress. The resulting ball 22 may have a surface roughness less than or equal to 0.1 Ra. For example, the burnishing process may be completed once the ball 22 exhibits a surface roughness between about 0.1 Ra and about 0.01 Ra, between about 0.08 Ra and about 0.01 Ra, between about 0.06 Ra and about 0.01 Ra, between about 0.05 Ra and about 0.01 Ra, or about 0.05 Ra.

With still continued reference to FIG. 1, the finish cutting module 38 may include a first rotational drive 48 that rotates the finish cutting tool in a first rotational direction R₁ with respect to the ball 22 and the burnishing module 40 may include a second rotational drive 50 that rotates the burnishing quill 48 in a second rotational direction R₂ with respect to the ball 22. In some implementations, the first rotational direction R₁ is opposite the second rotational direction R₂. In operation, the first and second rotational drives R₁, R₂ may be configured to follow, with the burnishing quill 46 in an opposite rotational direction, a surface of the ball 22 that has already interfaced with the finish cutting tool 42. The finish cutting tool 42 may, therefore, be configured to provide a finalized cutting or material removal step to the ball 22, while the burnishing quill 46 follows finish cutting tool 42 (e.g., in an opposite rotational direction) after the finalized cutting or material removal step to further smooth the surface of the ball 22 and create the microstructure layer.

To further improve performance of the burnishing quill 46, the interaction between the bearing 47, the sleeve 49, and the pressure medium 51 may together be referred to as a vibrational damper 52. The vibrational damper 52 is depicted as operating under the principles of hydrostatics. However, the vibrational damper 52 may alternatively or in addition to the hydrostatics include any dampening element (e.g., with elastic memory or constant force) that permits some movement of the burnishing quill 46 relative to the ball 22 and/or the bearing 47 relative to the sleeve 49 during the burnishing process. The vibrational damper 52 may beneficially keep pressure between the burnishing quill 46 and the ball 22 substantially constant to improve both uniform smoothness and thickness of the microstructure layer across the burnished surface of the ball 22. It should be appreciated that the finish cutting module 38 may likewise include a vibrational damper that operates (e.g., with elastic memory or constant force) in manners other than the principles of hydrostatics. Likewise, it should be appreciated that the burnishing module 40 may include a burnishing actuator 54 to effectuate movement of the burnishing quill 46 in similar directions and reasons as described above for the finish cutting actuator 44. However, it is contemplated that, in some implementations only one or neither of the finish cutting actuator 44 and the burnishing actuator 54 may be implemented in the machine assembly 10. After the steps at the finish workstation 16, the ball stud 300 is complete, but may require additional steps such as polishing, quality control testing, and/or the like.

The transfer of the preform 12 and ball stud 300 to, within, and from the machine assembly 10 one or more robotic arms 56 may be utilized. The number of robotic arms 56 may be varied depending on the number of machining stations 18 in the machine assembly 10. Each machining station 18 may include one, two, or more robotic arms 56. In some implementations, a single robotic arm 56 may load the preform 12 to the shaping workstation 14 until completion and then transfer the preform 12 from the shaping workstation to the finish workstation 16. While the preform 12 is in the finish workstation 16, the robotic arm 56 may then load another preform 12 into the shaping station 14 and unload the completed ball stud 300 in the finish workstation 14 to a loading dock or quality control station designated 58. In some implementations, one or more of the robotic arms 56 may be configured to load and unload the preform 12 from each machining station 18. For example, the one or more robotic arms 56 may initially load the preform 12 into the shaping 14 and remove the ball stud 300 from the finishing station 16. In some implementations, a conveyor or other preform transfer device may transfer the preform 12 between the shaping station 14 and the finishing station 16. In some implementations, the one or more robotic arms 56 may load and unload the preform 12 directly to and from the conveyor or other preform transfer device. The quality control station 58 may include one or more sensing modules that may be configured as auto-gauges, 3D vision systems, and/or the like to compare dimensions of the ball stud 300 with desired dimensions, which may be profiled in the control system 200. More particularly, as the various tools 28A-28C, 42 and/or the burnishing quill 46 are utilized throughout repeated processes, the interfacing surface of the various tools 28A-28C, 42 and the burnishing quill 46 may become worn, such that the predefined locations implemented by the various actuators 32, 34, 44 and 54 do not result in the same dimensional outcomes. The quality control station 58 may, therefore, generate and transmit dimensional measurements of the ball stud 300 to the control system 200 to automatically or recommend alternative placement via the various actuators 32, 34, 44 and 54 until the dimensions of the ball stud 300 match profiled and/or intended dimensions.

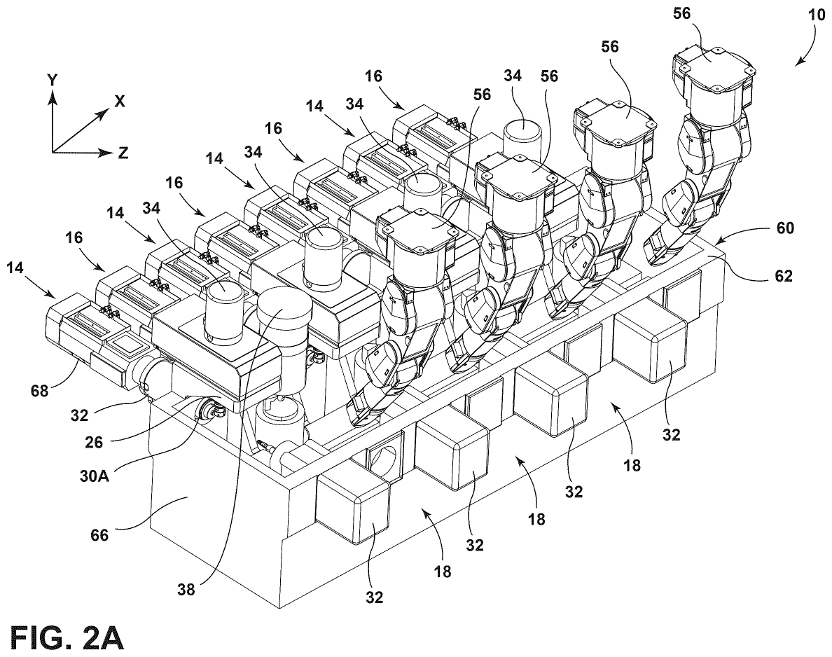

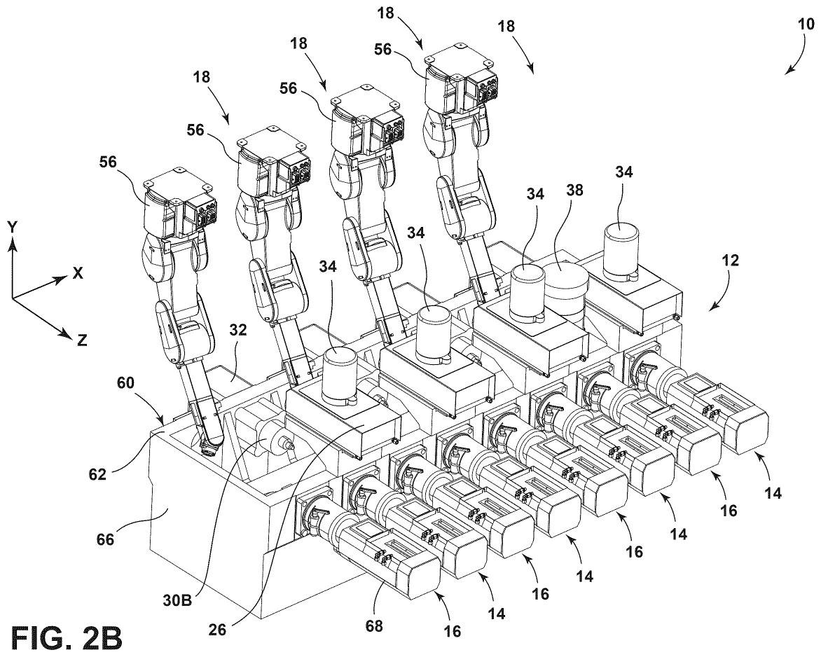

With reference now to FIGS. 2A and 2B, the machine assembly 10 is depicted in accordance with various implementations. In the depiction, the machine assembly 10 includes four separate machining stations 18 and each machining station 18 includes a robotic arm 56. However, it should be appreciated that more or less machining stations 18 may be present based on scaling considerations. The robotic arms 56 are mounted vertically to a ceiling or overhead structure and effectuate the movement of the preform 12 through each respective machining station 18. The machine assembly 10 may include a base 60 (e.g., machine casting or tub) for mounting the components of the different workstations 14, 16. In some implementations, the shaping and finishing processes may occur within the base 60. While the processes described in reference to the shaping and finishing stations 14, 16 may be dry (e.g., occurring in ambient air), in some implementations, the base 60 may contain a medium, such as an oil, that surrounds the preform 12 during the various processes. When implemented, the medium within the base 60 may reduce friction during the machining process and further be circulated within the base 60 (e.g., via a cooling manifold and a sump pump) to regulate a temperature of the preform 12 throughout the machining process. In some implementations, the base 60 may contain a conveyor that conveys out debris removed from the preform 12.

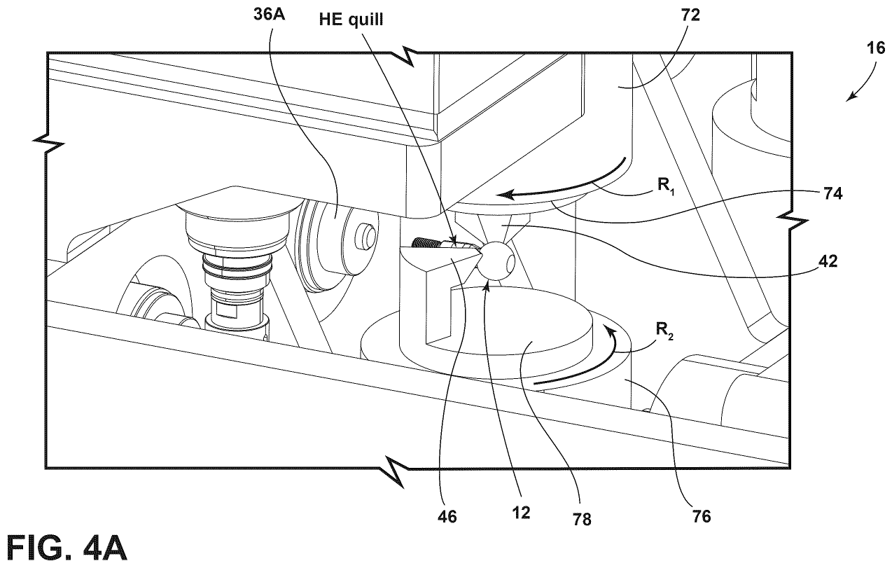

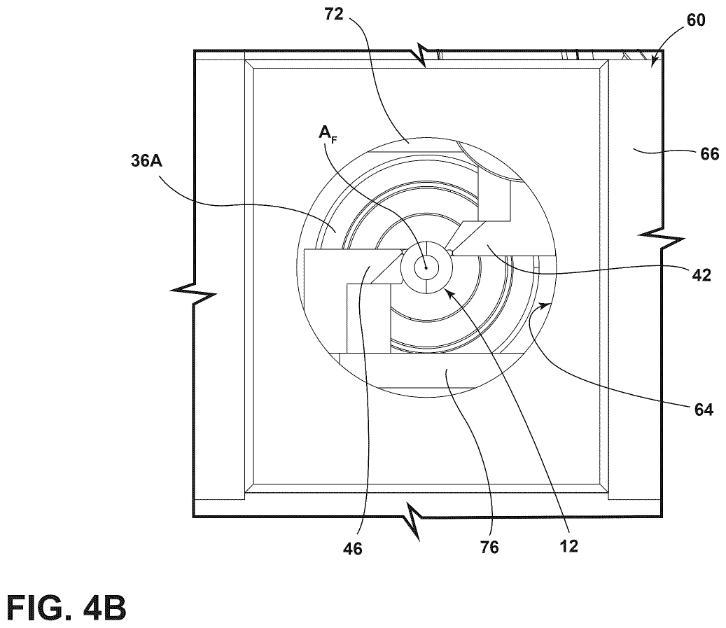

FIGS. 2A and 2B further depict components of the shaping workstation 14 and the finish workstation 16 in further detail. For example, the finish cutting module 38 and finish cutting tool 42 of each machining station 18 may be located in and movable within the base 60 and any medium contained in the base 60. Each of the various actuators 32, 34, 44 and 54 may be configured as servomechanisms in communication with and receive instructions from the control system 200. The servomechanisms may be operated by one or more motors (e.g., electrical motors), hydraulics, and/or the like for effectuating movement with respect to the environment as described in reference to FIG. 1. The robotic arms 56 may include one, two, or three joints that couple segments of the robotic arm 56 for 3D movement with respect to the X, Y, and Z axes. As depicted, each of the various actuators 32, 34, 44 and 54 may be located outside of the base 60 with, optionally, the burnishing actuator 54 and/or the second rotational drive 50 located in the base 60 but confined within a sealed housing. The base 60 may define a rim 62 and a series of apertures 64 (FIG. 4B) along a side surface 66 of the base 60 inset from the rim 62. The spindles 30A, 30B, 36A, 36B may be located within the apertures and sealed against the side of the base 60 via one or more gaskets or the like.

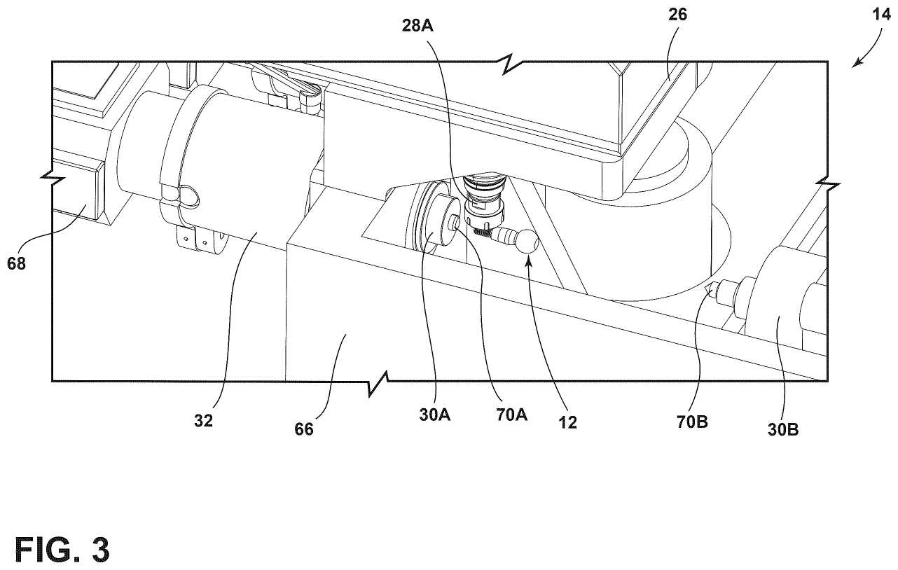

With reference now to FIG. 3, a top perspective view of the shaping workstation 14 is partially depicted. The first shaping spindle body 30A and/or the second shaping spindle body 30B may include a telescopic configuration with an internal body that moves (e.g., along the Z-axis) within an exterior body for engagement with the preform 12. The internal body may be rotationally coupled with the spindle actuators 32, which may be configured as servomotors. In some embodiments, only one of the first shaping spindle body 30A and the second shaping spindle body 30B is linearly movable to engage the preform 12. In other embodiments, both the first shaping spindle body 30A and the second shaping spindle body 30B may be linearly movable to engage the preform 12 and carry the preform along the Z-axis to align the various shaping tools 28A-28C along a profile of the preform 12. Linear movement of the first shaping spindle body 30A and/or the second shaping spindle body 30B may be effectuated by a linear actuator 68. The first shaping spindle body 30A and the second shaping spindle body 30B may each include an engagement surface 70A, 70B that holds the preform 12 in place from conjoint rotation. The engagement surfaces 70A, 70B may be the same or different. In the depicted implementation, the first shaping spindle body 30A includes a first engagement surface 70A that faces the stud 20 side of the preform 12 and is configured to hold one of the stud 20, the collar 24, or a surface of the ball 22. The second shaping spindle body 30B, likewise, may include a second engagement surface 70B that faces the ball 22 side of the preform 12 and may be configured to hold one of the collar 24 or a surface of the ball 22. When the preform 12 is engaged by engagement surfaces 70A, 70B, substantially an entire side profile of the preform 12 is exposed for machining by the shaping tools 28A-28C.

With reference now to FIGS. 4A and 4B, the finish workstation 16 is depicted from an upper perspective view and a side view, respectively. The finish cutting module 38 may include an outer sleeve 72 and an inner shaft 74 that is coupled to the finish cutting tool 42. In some implementations, the inner shaft 74 and outer sleeve 72 are coupled under the principles of hydrostatics as described above. More particularly, a medium (e.g., an oil) may be located between the inner shaft 74 and outer sleeve 72 and the inner shaft 74 may effectively float within the outer sleeve 72. In operation, the first rotational drive 48 may be configured as a servomotor that rotates the inner shaft 74 with respect to the outer sleeve 72. The burnishing module 40 may, likewise, include an outer sleeve 76 and an inner shaft 78 that is coupled to the burnishing tool 46. In some implementations, the inner shaft 78 and outer sleeve 76 may also or alternatively be coupled under the principles of hydrostatics as described above. More particularly, a medium (e.g., an oil) may be located between the inner shaft 78 and outer sleeve 76 and the inner shaft 78 may effectively float within the outer sleeve 76. In operation, the second rotational drive 50 may be configured as a servomotor that rotates the inner shaft 78 with respect to the outer sleeve 76 (e.g., in a rotational direction that is different than inner shaft 74).

The finish cutting tool 42 may be configured as diamond shaped insert with cutting surfaces (e.g., four cutting surfaces), the diamond shaped insert may have a geometry of between about 35° and about 55°. The diamond shaped insert may be utilized for obtaining a variety of dimensional options of the ball 22. In some implementations, the diamond shaped insert may be formed of carbide, cermet, ceramic, and/or the like. As depicted, during the finishing process, an edge of the finish cutting tool 42 may be held perpendicular to a surface of the ball 22. In some implementations, during the finishing process, the edge of the finish cutting tool 42 may also be held perpendicular to and aligned with the finish axis of rotation A_{F}. In some implementations, during the finishing process, the burnishing tool 46 may also be held perpendicular to a surface of the ball 22. In some implementations, during the finishing process, the burnishing tool 46 may also be held perpendicular to and aligned with the finish axis of rotation A_{F}. Further, a centerline (C.L.) of the ball 22 may extend through the axis of rotation A_{F}, as such both the burnishing tool 46 and the finish cutting tool 42 (e.g., the portions that are interfacing with the ball 22) may be aligned with the centerline C.L. and the axis of rotation A_{F} throughout the entire process at the finishing station 14. As such, as the preform 12 is rotated by the spindle bodies 36A, 36B, the burnishing tool 46 engages portions of the ball 22 (e.g., along the centerline C.L.) that have already been machined by the finish cutting tool 42 (e.g., along the centerline C.L.). In the depicted arrangement, the finish cutting tool 42 is located on a side profile of the ball 22 and the burnishing tool 46 is located on an opposite side profile of the ball 22 (e.g., aligned with the centerline C.L.). In other words, the finish cutting tool 42 and the burnishing tool 46 face one another on opposite sides of the ball 22 (e.g., aligned on opposite sides of the centerline C.L.). It should be appreciated that in FIG. 4B, spindle body 36B has been removed to show aperture 64 and the finish axis of rotation A_{F}. Again, it should be appreciated that the finish cutting tool 42 and the burnishing tool 46 may face one another and interact with opposite sides of the ball 22 substantially along the centerline C.L.

In operation, the first rotational drive R₁ may only rotate the finish cutting tool 42 along the first side profile to a top ball surface 22 and the second rotational drive R₂ may only rotate the burnishing tool 46 along the second side profile to the top ball surface 22. The rotational movement of the finish cutting tool 42 and the burnishing tool 46 may only occur once during the finishing process and reset to a starting location once the finishing process is completed in the finish workstation 16. The burnishing tool 46 may move rotationally along the finish axis of rotation A_{F} toward the top of the ball 22 and the finish cutting tool 42 may also move rotationally along the finish axis of rotation A_{F} toward the top of the ball 22 and be located (e.g., with respect to the finish axis of rotation A_{F}) between the top of the ball 22 and the burnishing tool 46. In this manner, the burnishing tool 46 primarily or substantially engages only surfaces of the ball 22 that have been machined by the finish cutting tool 42. The finish workstation 16 can accurately and consistently complete the finishing process efficiently once the preform 12 is received, for example, between 4 seconds and 12 seconds, between 4 seconds and 11 seconds, within 10 seconds or less, within 8 seconds, within 6 seconds or less, within 5 seconds or less, within 4 seconds or less, within 3 seconds or less, or within 2 seconds or less. In some implementations, the idling time (e.g., the time it takes to transfer subsequent preforms 12 to and from the finish workstation 16) can be about 6 seconds. Further, as detailed above, each machining station 18 can be scaled to finish multiple preforms simultaneously within the above timeframes, depending on the number of available machining stations 18. It should also be appreciated that the machine assembly 10 depicted in FIGS. 3-4B may not explicitly show each and every feature discussed in reference to FIG. 1 for the purposes of visibility of the discussed features in relation to FIGS. 3-4B.

With reference now to FIG. 5, a schematic illustration of the machine assembly 110 is depicted in accordance with a second arrangement. Unless otherwise explicitly indicated, the machine assembly 110 may share the same components, functionalities, and utilize the same processes as those described in reference to the machine assembly 10 of the first arrangement. More particularly, in the second arrangement, the machine assembly 110 receives a ball stud preform 12 and delivers the ball stud 300. It should be appreciated that the ball stud 300 that is delivered by the machine assembly 110 may or may not require additional processes prior to incorporation into an end application and use. Further, it should be appreciated that, as used herein, the term “ball stud preform” or “preform” may refer to the part prior to undergoing each of the processes as described herein. In the depicted illustration, the machine assembly 110 includes a shaping workstation 114 and a finish workstation 116, which together may define a machining station 118 that receives one of the preforms 12 and delivers one of the ball studs 300. While the machine assembly 110 is only depicted as including a single machining station 118, it should be appreciated that the machine assembly 110 may be scaled to include two, three, four, or more machining stations 118 that each form ball studs 300 in parallel or sequence. In the depicted arrangement in FIG. 5, the process 250 moves from left to right or along a designated X-axis. Different components of the machine assembly 110 will be described as moving or rotating relative to the X-axis, a designated Y-axis which may also be referred to as a vertical direction, and/or a designated Z-axis which projects from or away from the drawing depicted in FIG. 5.

As will be described in greater detail below, the workstations 114, 116 may modify the shape and/or material of the preform. Further, it should be appreciated that while both the shaping workstation 114 and the finish workstation 116 may generally operate under the same principles as the shaping workstation 14 and a finish workstation 16 in FIG. 1, various distinctions will be noted below. Likewise, it should be appreciated that the machine assembly 10, 110 may include aspects of both the first and second arrangements without departing from the scope of the subject disclosure. For example, a machine assembly 10, 110 may employ the shaping workstation 14 of the first arrangement and the finish workstation 116 of the second arrangement. Similarly, in some implementations, a machine assembly 10, 110 may employ the shaping workstation 114 of the second arrangement and the finish workstation 16 of the first arrangement. Further details of the machine assembly 110 are described below and depicted throughout FIGS. 5-8C. Generally, any of these features, unless explicitly stated, may be incorporated into the machine assembly 10 of the first arrangement. Similarly, unless explicitly stated, any of the features previously described in reference to the machine assembly 10 of the first arrangement may be incorporated into the machine assembly 110 of the second arrangement.

With reference now to FIGS. 5-7, the shaping workstations 114 may have at least one shaping module 126 that is coupled to at least one shaping tool 128A-128D for removing material from and shaping the preform 12. More particularly, cutting tools, lathes, threaders, grinders, and/or the like may be utilized for shaping, roughening (e.g., performing the rough turning on) different portions of the preform 12. In some implementations, the at least one shaping module 126 may further include finishing tools, such as a finish cutting tool and/or a burnishing quill. In some implementations, the at least one shaping tool 128A-128D may be configured to, for example, taper or shape the stud portion 20 and/or the collar portion 24 (e.g., the undercut), shape the ball 22, add threading to the stud portion 20, and/or the like. In some implementations, the at least one shaping tool 128A-128D may include more than one shaping tool 128A-128D. For example, the at least one shaping tool 128A-128D may include at least a first shaping tool 128A, a second shaping tool 128B, a third shaping tool 128C, and a fourth shaping tool 128D. However, it should be appreciated that the at least one shaping tool 128A-128D may be more or less shaping tools 128A-128D than those depicted. Each of the shaping tools 128A-128D depicted in FIG. 5 may be uniquely configured to perform a different task on the preform 12 (e.g., shaping, adding threads, tapers, and/or the like) including those functionalities listed above.

The shaping workstation 114 in the machine assembly 110 of the second arrangement may include some differences to the shaping workstation 14 in the machine assembly 10 of the first arrangement. More particularly, while generally the same types of shaping tools 128A-128D for removing material from and shaping the preform 12 may be implemented, the arrangement and movement of the shaping tools 128A-128D is distinct. As best depicted in FIGS. 5-7, the at least one shaping module 126 may include a pair of shaping modules 126 that may each be coupled to different ones of the shaping tools 128A-128D. The shaping modules 126 may be located on opposite sides of the preform 12 and/or space configured to locate the preform during the initial machining step. In the depicted arrangement, one shaping module 126 includes two shaping tools 128A, 128B and the other shaping module 126 includes two shaping tools 128C, 128D. However, it should be appreciated that any number of shaping tools 128A-128D may be coupled to both the shaping modules 126 in equal or different numbers. In this manner, when two shaping modules 126 are utilized one at least one shaping tool 128A-128D from one of the shaping tool 128A-128D may be used simultaneously with at least one shaping tool 128A-128D from a different one of the shaping modules 126. In this manner, two or more shaping operations and/or finishing operations may be utilized in the same workstation 114 simultaneously and/or in sequence.

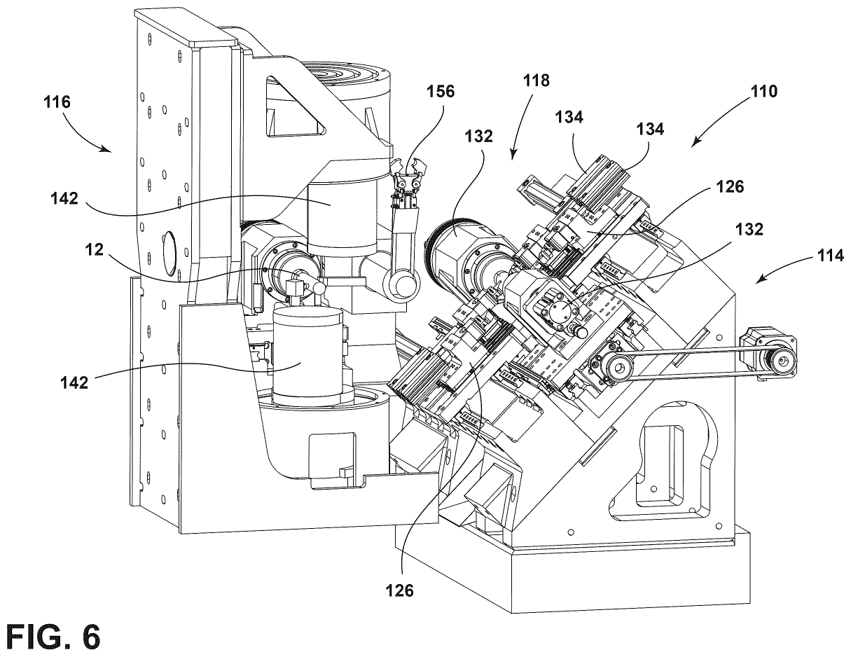

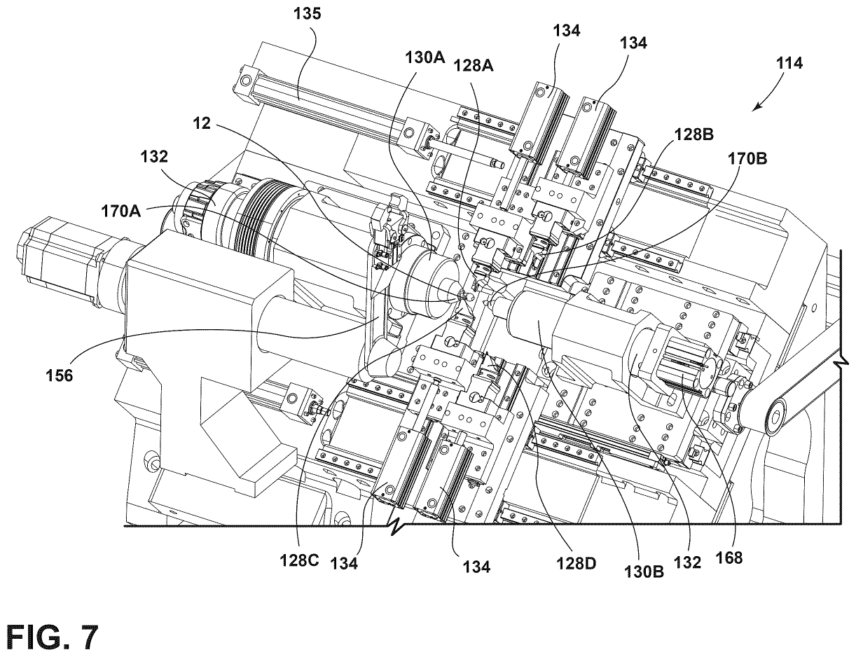

In operation, the preform 12 is loaded into a shaping spindle 130A, 130B that may include a first shaping spindle body 130A and a second shaping spindle body 130B. However, it is contemplated that only one spindle body 130A may be utilized. More particularly, at least one of the first shaping spindle body 130A and the second shaping spindle body 130B may move towards and away from each other towards opposite ends of the preform 12. In some implementations, both the first shaping spindle body 130A and the second shaping spindle body 130B may move towards and away from each other along the Z-axis as indicated by arrows. However, in the depicted implementations shown in FIGS. 6 and 7, both the first shaping spindle body 130A and the second shaping spindle body 130B may move at an intermediate axis between the Z and Y axes. The shaping spindle bodies 130A, 130B clamp different surfaces of the preform 12 (e.g., the stud portion 20, the ball 22, and/or the collar 24) and both rotate, as indicated by rotational arrows, in concert to rotate the preform 12 along a shaping axis of rotation Aₛ. The shaping axis of rotation Aₛ may be aligned and parallel with the movement of the spindle bodies 130A, 130B and generally centers and movement of the shaping spindle bodies 130A, 130B (e.g., along the intermediate axis).

The shaping modules 126 may be affixed to different ones of the shaping tools 128A-128D and movable transverse to the shaping axis of rotation Aₛ and, more particularly, perpendicular to the shaping axis of rotation Aₛ to bring one or more of the shaping tools 128A-128D into contact with the rotating preform (e.g., perpendicularly). During the engagement between the one or more shaping tools 128A-128D and the preform, at least one of the shaping spindle bodies 130A, 130B and the shaping module 126 may be movable along the shaping axis of rotation Aₛ (e.g., the intermediate axis) to align the one or more shaping tools 128A-128D with different surfaces of the preform 12. In some implementations, the shaping spindle bodies 130A, 130B move the preform 12 along the shaping axis of rotation Aₛ during the shaping process. More particularly, one or more spindle actuators 132 may be configured to move the shaping spindle bodies 130A, 130B linearly (e.g., along the shaping axis of rotation Aₛ) and rotationally (e.g., about the shaping axis of rotation Aₛ). In other implementations, the shaping modules 126 may move the shaping tools 128A-128D along the shaping axis of rotation Aₛ in addition to or alternatively from the shaping spindle bodies 130A, 130B.

The shaping modules 126 may each include one or more shaping module actuators 134, 135 for selectively moving the one or more shaping tools 128A-128D into engagement with the preform 12 and dictating the depth of material removal and dimensions of the preform after and/or during the shaping process. The movement of the shaping tools 128A-128D into and out of engagement with the preform 12 may be bidirectional. More particularly, both of the shaping modules 126 may include a first actuator 134 (e.g., a plurality of first actuators 134) coupled to each of the shaping tools 128A-128D that selectivity and independently move selected ones of the shaping tools 128A-128D towards and away (e.g., perpendicularly) from the shaping axis of rotation Aₛ to define a depth of the machining. The shaping modules 126 may each further include a second actuator 135 that move the shaping tools 128A-128D along the shaping axis of rotation Aₛ into alignment with the preform 12. In this manner, the second actuator 135 may be moved to align a selected shaping tools 128A-128D with a region of the preform 12 that needs to be machined while the first actuator 134 moves the shaping tools 128A-128D towards the preform 12 to define a depth. By utilizing two shaping modules 126 that may each include one or shaping tools 128A-128D, the shaping workstations 114 allows for different shaping tool 128A-128D selection and simultaneous utilizing of two shaping tools 128A-128D from different shaping modules 126. In this manner, the shaping modules 126, via the actuators 134, 135, may be movable transverse (e.g., along the X-axis) to the shaping axis of rotation Aₛ in order to selectively bring some (e.g., one) but not all of the shaping tools 128A-128D into contact with the preform 12 to permit several different machining/shaping steps to be completed in the shaping workstation 114. The shaping tools 128A-128D may therefore be referred to as a collection of shaping tools that can be individually moved via the shaping modules 126 into and out of engagement with the preform 12.

When two shaping tools 128A-128D are utilized simultaneously, one of the shaping tools 128A-128D may effectively follow (e.g., on a diametrically opposite side) another shaping tools 128A-128D along the shaping axis of rotation Aₛ during the machining process. In this manner, two or more shaping processes may be carried out simultaneously for added efficiency. Likewise, in some implementations, the shaping tools 128A-128D may include two or more groupings of shaping tools 128A-128D specifically designed to machine the preform 12 into a ball stud 300 of varying dimensions and/or configurations, such that retooling is quicker and automated. Similarly, in some implementations, the shaping tools 128A-128D may include two or more groupings of shaping tools 128A-128D specifically designed to machine the preform 12 into a ball stud 300 of the same dimension and/or configuration, such that wear and tear on the shaping tools 128A-128D is limited and overheating and/or overworking the shaping tools 128A-128D can be avoided. More particularly, the first group of shaping tools 128A-128D may be utilized for a predetermined number of duty cycles and/or to a certain level of detectable wear before the control system 200 automatically switches to the second group of shaping tools 128A-128D.

In operation, while the preform 12 is rotated, the shaping module actuators 134, 135 can move the shaping module 126 and, by extension, one of the shaping tools 128A-128D into and out of engagement with the preform 12 along or transverse (e.g., perpendicular to) the shaping axis of rotation Aₛ. When one or more new shaping tools 128A-128D are needed, the shaping module actuators 134 can move the currently engaged shaping tool or tools 128A-128D away from the preform 12 and then move the shaping tools 128A-128D along the shaping axis of rotation Aₛ (e.g., with actuator 135) until one or more different shaping tools 128A-128D are aligned with the preform 12. Once the one or more different shaping tools 128A-128D are aligned with the preform 12, the shaping module actuators 134 can move the selected shaping tools 128A-128D towards the preform 12 (e.g., towards the shaping axis of rotation Aₛ) for reengagement. The shaping spindle bodies 130A, 130B may continue to rotate the preform 12 throughout the entire shaping process as different ones of the shaping tools 128A-128D are selected and utilized.

The shaping spindle bodies 130A, 130B may rotate between about 2,000 to about 7,000 RPMs. For example, the shaping spindle bodies 130A, 130B may rotate between about 3,000 to about 7,000 RPMs, between about 4,000 to about 7,000 RPMs, between about 5,000 to about 7,000 RPMs, or between about 5,000 to about 6,000 RPMs. The shaping module actuators 135 may be configured to adjust a depth of material removal in a nano or micron scale. In this manner, the conjoint movement between the shaping spindle bodies 130A, 130B and the shaping modules 126 and/or shaping tools 128A-128D can accurately and consistently complete the shaping process efficiently once the preform 12 is received, for example, between 4 seconds and 12 seconds, between 4 seconds and 11 seconds, within 10 seconds or less, within 8 seconds, within 6 seconds or less, within 5 seconds or less, within 4 seconds or less, within 3 seconds or less, or within 2 seconds or less. In some implementations, the idling time (e.g., the time it takes to transfer subsequent preforms 12 to and from the shaping workstation 114) can be about 6 seconds. Further, as detailed above, each machining station 118 can be scaled to shape multiple preforms simultaneously within the above timeframes, depending on the number of available machining stations 118.

With reference now to FIGS. 5, 6, and 8A-8C, after the shaping steps have been completed in the shaping workstation 114, the preform 12 may be transferred (e.g., along the X-axis) to the finish workstation 116. It should be appreciated that while designated the “finish station,” the preform 12 may nonetheless undergo additional shaping in the finish workstation 116 and/or finishing steps after the finish workstation 116. More particularly, the finish station 116 may include a finish spindle 136A, 136B configured to couple and rotate (e.g., via spindle actuators 132) the preform 12 about a finish axis of rotation A_{F} relative to a finish cutting module 138 (e.g., a finish turning module) and a burnishing module 140. However, it is contemplated that only one spindle body 136A may be utilized. The finish cutting module 138 may include a finish cutting tool 142 and a finish cutting actuator 144 configured to move an edge of the finish cutting tool 142 into engagement with the ball 22 of the preform 12 (e.g., along the X-axis or the Y-axis). The burnishing module 140 may include a burnishing quill 146 configured to contact and burnish an exterior surface of the ball 22. While the burnishing module 140 and the burnishing quill 146 (i.e., and associated components) are depicted as being lower along the vertical axis Y than the finish cutting module 138 the finish cutting tool 142 (e.g., and associated components), the locations of both may be switched. For example, the burnishing module 140 and the burnishing quill 146 (i.e., and associated components) may be higher along the vertical axis Y than the finish cutting module 138 the finish cutting tool 142 (e.g., and associated components).

The burnishing quill 146 may be configured as a low plasticity burnishing quill or, more specifically, a hydrostatic quill. The burnishing quill 146 induces a layer with internal residual stress within the ball 22. Under the principles of burnishing and, more particularly, hydrostatic burnishing, the burnishing quill 146 may include a shape (e.g., a bearing 147 having a spherical shape) is hydrostatically held within a holder (e.g., an outer sleeve 149). The bearing 147 may effectively float within the sleeve 149 to prevent metal-on-metal contact. The bearing 147 is pressed onto a surface of a workpiece (e.g., a surface of the ball 22) and the friction and forces between the bearing 147 and the ball 22 plastically deform and smooth the ball 22 while changing the microstructure of an outer layer of the ball that exhibits improved fatigue strength. As will be described in greater detail below, the friction and forces via the burnishing process may include a pressure medium 151, such as a liquid, oil, or air that can be located between the bearing 147 and sleeve 149 to facilitate the floating of the bearing 147 and vibrationally dampen the burnishing process. In this manner, the burnishing quill both improves the smoothness of the ball 22 and creates a layer with a microstructure that exhibits internal residual stress. The resulting ball 22 may have a surface roughness less than or equal to 0.1 Ra. For example, the burnishing process may be completed once the ball 22 exhibits a surface roughness between about 0.1 Ra and about 0.01 Ra, between about 0.08 Ra and about 0.01 Ra, between about 0.06 Ra and about 0.01 Ra, between about 0.05 Ra and about 0.01 Ra, or about 0.05 Ra.

With still continued reference to FIGS. 5, 6, and 8A-8C, the finish cutting module 138 may include a first rotational drive 148 (e.g., a servomotor) that rotates the finish cutting tool in a first rotational direction R₁ with respect to the ball 22 and the burnishing module 140 may include a second rotational drive 150 (e.g., a servomotor) that rotates the burnishing quill 148 in a second rotational direction R₂ with respect to the ball 22. In some implementations, the first rotational direction R₁ is opposite the second rotational direction R₂. In operation, the first and second rotational drives R₁, R₂ may be configured to follow, with the burnishing quill 146 in an opposite rotational direction, a surface of the ball 22 that has already interfaced with the finish cutting tool 142. The finish cutting tool 142 may, therefore, be configured to provide a finalized cutting or material removal step to the ball 22, while the burnishing quill 146 follows finish cutting tool 142 (e.g., in an opposite rotational direction) after the finalized cutting or material removal step to further smooth the surface of the ball 22 and create the microstructure layer.

To further improve performance of the burnishing quill 146 and the finish cutting tool 142 and more specifically, the interaction between the bearing 147, the sleeve 149, and the pressure medium 151 may together be referred to as a vibrational damper 152. The vibrational damper 152 is depicted as operating under the principles of hydrostatics. However, the vibrational damper 152 may alternatively or in addition to the hydrostatics include any dampening element (e.g., with elastic memory or constant force) that permits some movement of the burnishing quill 146 relative to the ball 22 and/or the bearing 147 relative to the sleeve 149 during the burnishing process. The vibrational damper 152 may beneficially keep pressure between the burnishing quill 146 and the ball 22 substantially constant to improve both uniform smoothness and thickness of the microstructure layer across the burnished surface of the ball 22. It should be appreciated that the finish cutting module 138 may likewise include a vibrational damper that operates (e.g., with elastic memory or constant force) in manners other than the principles of hydrostatics. Likewise, it should be appreciated that the burnishing module 140 may include a burnishing actuator 154 to effectuate movement of the burnishing quill 146 in similar directions and reasons as described above for the finish cutting actuator 144. However, it is contemplated that, in some implementations, only one or neither of the finish cutting actuator 144 and the burnishing actuator 154 may be implemented in the machine assembly 110. After the steps at the finish workstation 116, the ball stud 300 is complete, but may require additional steps such as polishing, quality control testing, and/or the like.

The transfer of the preform 12 and ball stud 300 to, within, and from the machine assembly 110 one or more transfer arms 156 may be utilized. It should be appreciated that the transfer arms 156 may be implemented in the machine assembly 10 rather than the transfer arms 56 and, likewise, the transfer arms 56 may be implemented in the machine assembly 110. The number of transfer arms 156 may be varied depending on the number of machining stations 118 in the machine assembly 10. Each machining station 118 may include one, two, or more transfer arms 156. In some implementations, a single transfer arm 156 may load the preform 12 to the shaping workstation 114 until completion and then transfer the preform 12 from the shaping workstation to the finish workstation 116. While the preform 12 is in the finish workstation 116, the transfer arm 156 may then load another preform 12 into the shaping station 114 and unload the completed ball stud 300 in the finish workstation 114 to a loading dock or quality control station designated 158. In some implementations, one or more of the transfer arms 156 may be configured to load and unload the preform 12 from each machining station 118. For example, the one or more transfer arms 156 or alternatively pick-and-place mechanisms may initially load the preform 12 into the shaping 114 and remove the ball stud 300 from the finishing station 116. In some implementations, a conveyor or other preform transfer device may transfer the preform 12 between the shaping station 114 and the finishing station 116. In some implementations, the one or more transfer arms 156 may load and unload the preform 12 directly to and from the conveyor or other preform transfer device. In the depicted implementation, the transfer arm 156 is shown as an arm with a gripper or clamp end that pivots between the shaping workstation 114 and the finish workstation 116. The quality control station 158 may include one or more sensing modules that may be configured as auto-gauges, 3D vision systems, and/or the like to compare dimensions of the ball stud 300 with desired dimensions, which may be profiled in the control system 200. More particularly, as the various tools 128A-128D, 142 and/or the burnishing quill 146 are utilized throughout repeated processes, the interfacing surface of the various tools 128A-128D, 142 and the burnishing quill 146 may become worn, such that the predefined locations implemented by the various actuators 132, 134, 144 and 154 do not result in the same dimensional outcomes. The quality control station 158 may, therefore, generate and transmit dimensional measurements of the ball stud 300 to the control system 200 to automatically or recommend alternative placement via the various actuators 132, 134, 135, 144 and 154 or different selections of the various tools 128A-128D until the dimensions of the ball stud 300 match profiled and/or intended dimensions.

With reference now to FIGS. 6-8C, the machine assembly 110 is depicted in accordance with various implementations. While not explicitly shown, the machine assembly 110 may include four or more separate machining stations 118 and each machining station 118 may include a transfer arm 156 as generally shown in reference to the machine assembly 10 in FIGS. 2A and 2B. However, it should be appreciated that more or less machining stations 118 may be present based on scaling considerations. In some implementations, the machine assembly 110 may include a base (e.g., with a medium) similar to base 60 depicted in reference to the machine assembly 10 of the first arrangement. It should also be appreciated that the machine assembly 110 depicted in FIGS. 6-8C may not explicitly show each and every feature discussed in reference to FIG. 5 for the purposes of visibility of the discussed features in relation to FIGS. 6-8C.

Each of the various actuators 132, 134, 135, 144 and 154 may be configured as servomechanisms in communication with and receive instructions from the control system 200. The servomechanisms may be operated by one or more motors (e.g., electrical motors), hydraulics, and/or the like for effectuating movement with respect to the environment as described in reference to FIG. 5. The transfer arms 156 may include a pivotal body with no joints. Much like the machine assembly 10 of the first arrangement, the first shaping spindle body 130A and/or the second shaping spindle body 130B may include a telescopic configuration with an internal body that moves (e.g., along the intermediate axis) within an exterior body for engagement with the preform 12. The internal body may be rotationally coupled with the spindle actuators 132, which may be configured as servomotors. In some embodiments, only one of the first shaping spindle body 130A and the second shaping spindle body 130B is linearly movable to engage the preform 12. In other embodiments, both the first shaping spindle body 130A and the second shaping spindle body 130B may be linearly movable to engage the preform 12 and carry the preform along the Z-axis to align the various shaping tools 128A-128D along a profile of the preform 12. Linear movement of the first shaping spindle body 130A and/or the second shaping spindle body 130B may be effectuated by a linear actuator 168. The first shaping spindle body 130A and the second shaping spindle body 130B may each include an engagement surface 170A, 170B that holds the preform 12 in place from conjoint rotation. The engagement surfaces 170A, 170B may be the same or different. In the depicted implementation, the first shaping spindle body 130A includes a first engagement surface 170A that faces the stud 20 side of the preform 12 and is configured to hold one of the stud 20, the collar 24, or a surface of the ball 22. The second shaping spindle body 130B, likewise, may include a second engagement surface 170B that faces the ball 22 side of the preform 12 and may be configured to hold one of the collar 24 or a surface of the ball 22. When the preform 12 is engaged by engagement surfaces 170A, 170B, substantially an entire side profile of the preform 12 is exposed for machining by the shaping tools 128A-128D.

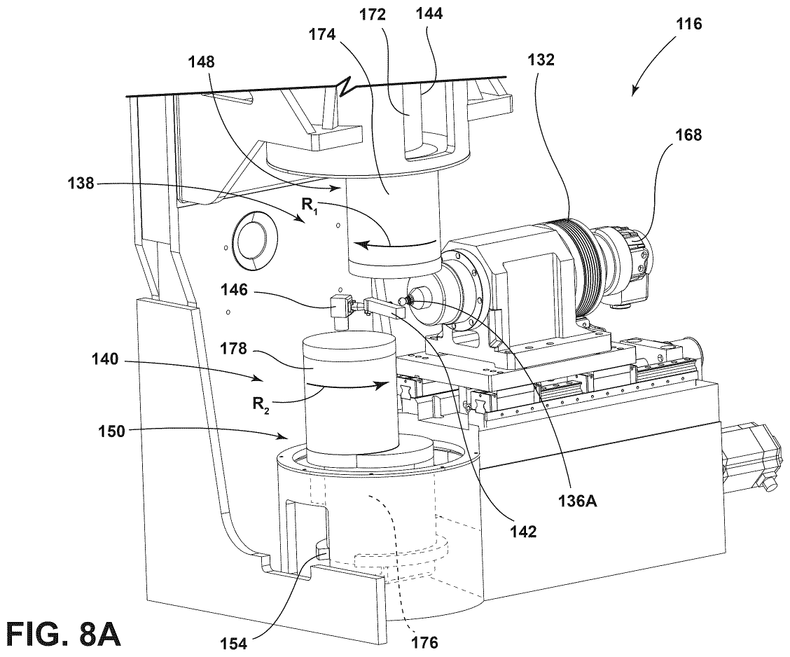

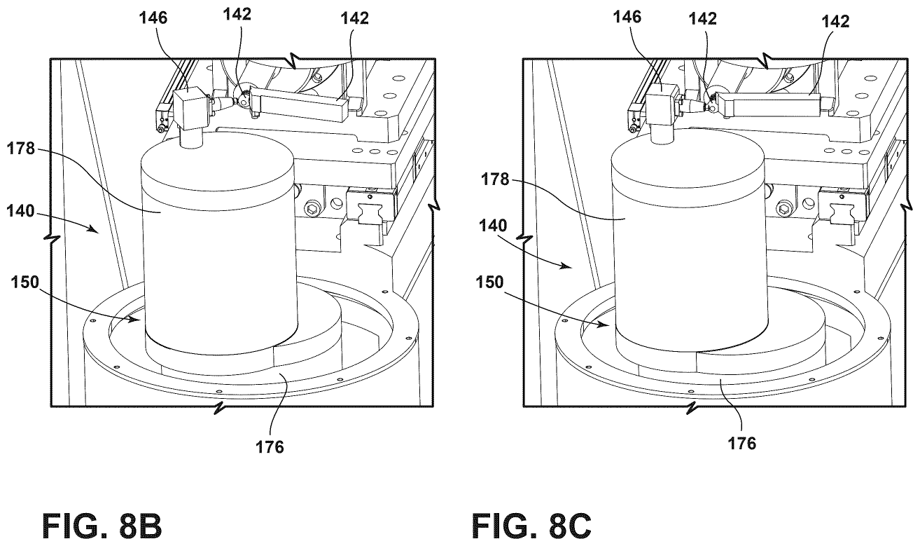

With reference now to FIGS. 8B and 8C, the finish workstation 116 is depicted from an upper perspective view and shows additional features and components of the finish workstation 116. To further improve performance of the burnishing quill 146 and/or the finish cutting tool 142 and more specifically, to provide vibrational dampening between the burnishing quill 146 and/or the finish cutting tool 142 and the preform 12, further dampening mechanisms may be utilized in addition to or alternatively from the vibrational damper 152. More particularly, the finish cutting module 138 may include an outer sleeve 172 and an inner shaft 174 that is coupled to the finish cutting tool 142. In some implementations, the inner shaft 174 and/or outer sleeve 172 are coupled under the principles of hydrostatics as described above. More particularly, a medium (e.g., an oil) may be located between the inner shaft 174 and outer sleeve 172 and/or the outer sleeve 172 and a rotational base that couples the outer sleeve 172 to finish workstation 116. In this manner, at least one of the inner shaft 174 and/or the outer sleeve 172 may effectively float during rotation under the principles of statistics. One distinction between the outer sleeve 172 and the inner shaft 174 in the machine assembly 110 is that the outer sleeve 172 may extend along an outer sleeve axis and the inner shaft 174 may extend along an inner shaft axis that is not aligned with the outer sleeve axis but may be parallel. More particularly, as the inner shaft 174 is rotated, the inner shaft axis may move circumferentially about the outer sleeve axis. In this manner, both the outer sleeve 172 and the inner shaft 174 may be statically coupled to one another and rotate together (e.g., about a rotational base that couples the outer sleeve 172 to finish workstation 116). Because both machine assemblies 10, 110 may include hydrostatic vibrational dampening 52, 152 in addition to hydrostatic dampening of the sleeves, both machine assemblies 10, 110 may be referred to as having two or more vibrational dampening mechanisms and, more particularly, two or more hydrostatic vibrational dampening mechanisms.

In operation, the first rotational drive 148 may be configured as a servomotor that rotates the inner shaft 174 and/or the outer sleeve 172. The burnishing module 140 may, likewise, include an outer sleeve 176 and an inner shaft 178 that is coupled to the burnishing tool 146. In some implementations, the inner shaft 178 and outer sleeve 176 may also or alternatively be coupled under the principles of hydrostatics as described above. More particularly, a medium (e.g., an oil) may be located between the inner shaft 178 and outer sleeve 176 and/or the outer sleeve 176 and a rotational base that couples the outer sleeve 176 to finish workstation 116. In this manner, at least one of the inner shaft 178 and/or the outer sleeve 176 may effectively float during rotation under the principles of statistics. One distinction between the outer sleeve 176 and the inner shaft 178 in the machine assembly 110 is that the outer sleeve 176 may extend along an outer sleeve axis and the inner shaft 178 may extend along an inner shaft axis that is not aligned with the outer sleeve axis but may be parallel. More particularly, as the inner shaft 178 is rotated, the inner shaft axis may move circumferentially about the outer sleeve axis. In this manner, both the outer sleeve 176 and the inner shaft 178 may be statically coupled to one another and rotate together (e.g., about a rotational base that couples the outer sleeve 176 to finish workstation 116).

The finish cutting tool 142 may be configured as diamond shaped insert with cutting surfaces (e.g., four cutting surfaces), the diamond shaped insert may have a geometry of between about 35° and about 55°. The diamond shaped insert may be utilized for obtaining a variety of dimensional options of the ball 22. In some implementations, the diamond shaped insert may be formed of carbide, cermet, ceramic, and/or the like. As depicted, during the finishing process, an edge of the finish cutting tool 142 may be held perpendicular to a surface of the ball 22. In some implementations, during the finishing process, the edge of the finish cutting tool 142 may also be held perpendicular to and aligned with the finish axis of rotation A_{F}. In some implementations, during the finishing process, the burnishing tool 146 may also be held perpendicular to a surface of the ball 22. In some implementations, during the finishing process, the burnishing tool 146 may also be held perpendicular to and aligned with the finish axis of rotation A_{F}. Further, a centerline (C.L.) of the ball 22 may extend through the axis of rotation A_{F}, as such both the burnishing tool 146 and the finish cutting tool 142 (e.g., the portions that are interfacing with the ball 22) may be aligned with the centerline C.L. and the axis of rotation A_{F} throughout the entire process at the finishing station 114. As such, the preform 12 is rotated by the spindle bodies 136A, 136B, the burnishing tool 146 engages portions of the ball 22 (e.g., along the centerline C.L.) that have already been machined by the finish cutting tool 142 (e.g., along the centerline C.L.). In the depicted arrangement, the finish cutting tool 142 is located on a side profile of the ball 22 and the burnishing tool 146 is located on an opposite side profile of the ball 22 (e.g., aligned with the centerline C.L.). In other words, the finish cutting tool 142 and the burnishing tool 146 face one another on opposite sides of the ball 22 (e.g., aligned on opposite sides of the centerline C.L.). It should be appreciated that in FIG. 8A, spindle body 136B may not be present or has otherwise been removed. Again, it should be appreciated that the finish cutting tool 142 and the burnishing tool 146 may face one another and interact with opposite sides of the ball 22 substantially along the centerline C.L.

In operation, the first rotational drive R₁ may only rotate the finish cutting tool 142 along the first side profile to a top ball surface 22 and the second rotational drive R₂ may only rotate the burnishing tool 146 along the second side profile to the top ball surface 22. The rotational movement of the finish cutting tool 142 and the burnishing tool 146 may only occur once during the finishing process and reset to a starting location once the finish process is completed in the finish workstation 116. The burnishing tool 146 may move rotationally along the finish axis of rotation A_{F} toward the top of the ball 22 and the finish cutting tool 142 may also move rotationally along the finish axis of rotation A_{F} toward the top of the ball 22 and be located (e.g., with respect to the finish axis of rotation A_{F}) between the top of the ball 22 and the burnishing tool 146. In this manner, the burnishing tool 146 primarily or substantially engages only surfaces of the ball 22 that have been machined by the finish cutting tool 142. The finish workstation 116 can accurately and consistently complete the finishing process efficiently once the preform 12 is received, for example, between 4 seconds and 12 seconds, between 4 seconds and 11 seconds, within 10 seconds or less, within 8 seconds, within 6 seconds or less, within 5 seconds or less, within 4 seconds or less, within 3 seconds or less, or within 2 seconds or less. In some implementations, the idling time (e.g., the time it takes to transfer subsequent preforms 12 to and from the shaping workstation 14) can be about 6 seconds. Further, as detailed above, each machining station 118 can be scaled to finish multiple preforms simultaneously within the above timeframes, depending on the number of available machining stations 118.

With reference now to FIG. 9, the control system 200 of the machine assembly 10, 110 may include at least one electronic control unit (ECU) 202. The at least one ECU 202 may be located in a singular packaging or housing or be distributed throughout the machine assembly 10, 110 (e.g., at each machining station 18, 118 or workstation 14, 16, 114, 116). The at least one ECU 202 may include the processor 204 and a memory 206. The processor 204 may include any suitable processor 204. Additionally, or alternatively, each ECU 202 may include any suitable number of processors, in addition to or other than the processor 204. The memory 206 may comprise a single disk or a plurality of disks (e.g., hard drives) and includes a storage management module that manages one or more partitions within the memory 206. In some embodiments, memory 206 may include flash memory, semiconductor (solid-state) memory, or the like. The memory 206 may include Random Access Memory (RAM), a Read-Only Memory (ROM), Electrically Erasable Programmable Read-Only Memory (EEPROM), or a combination thereof. The memory 206 may include instructions that, when executed by the processor 204, cause the processor 204 to, at least, perform the functions associated with operational aspects of the components of the machine assembly 10, 110.

The memory 206 may include a series of ball stud profiles 208 that include dimensional and shape information for particular models, shapes, and sizes of ball studs 300. These profiles may be selected to adjust the machining steps carried out in the shaping workstation 14, 114 and finishing workstation 16, 114. For example, the location, amount, and pattern of material removal, final dimensions, and/or the like may be selected via profiles 208. Once selected, the control system 200 may communicate, for example, with actuators (e.g., associated with element numerals 32, 34, 44, 54, 132, 134, 135, 144, and 154), rotational drives 48, 50, 148, 150 and shaping tool 28A-28C, 128A-128D selections. The memory 206 may further include a quality control module 210 that receives dimensional information from the quality control station 58, 158, compares the dimensional information with the ball stud profiles 208 and either adjusts or makes a recommendation (e.g., via a user interface) to adjust components of the machine assembly 10, 110. In some embodiments, the memory 206 may include an operational parameter module 212 that, based on the ball stud profiles 208 scales the concerted operation of the available or desired number of machining stations 18. In some implementations, the control system 200 may include a communication module 214 in operable communication with the actuators (e.g., associated with element numerals 32, 34, 44, 54, 132, 134, 135, 144, and 154), rotational drives 48, 50, 148, 150 shaping tool 28A-28C, 128A-128D, and/or other components of the machine assembly 10, 110 as described above. Communication may be wired, wireless, or a combination of both wired and wireless. Generally speaking, the control system 200 may be configured to effectuate any of the operational steps described throughout.

With reference now to FIG. 10, the process 250 of shaping (e.g., turning) a ball stud 300 from a preform 12 is depicted. The process 250, for example, may occur after a near net shape cold forming step where the preform 12 is initially formed and may be further modified via heat treatment before the steps described herein. Cold forming can result in the ball stud 300 (e.g., and preform 12) that is harder, has improved yield, higher tensile strength, and a superior surface smoothness. It should be appreciated that, in addition to the steps described below, the process 250 may include any of the operational steps described throughout in conjunction with the structural components of the machine assembly 10 and/or the machine assembly 110 and via the instructions provided by the control system 200. The depicted process 250 includes, at 252, shaping a preform at a shaping station. Step 252 may implement all the operational steps and structural components of the machine assembly 10 and/or the machine assembly 110 described throughout. For example, the preform may be rotated about a shaping axis of rotation Aₛ. At step 254, the process 250 may include transferring the preform to a finish station. For example, the preform may be transferred to the finish station via one or more robotic arms as described herein. At step 256, the process 250 may include rotating the preform about a finish axis of rotation. For example, via finish spindle bodies 36A, 36B or 136A, 136B. At step 258, the process 250 may include rotating a finish cutting tool in a first rotational direction with respect to a ball of the preform. For example, along a first side profile of the preform. At step 260, the process 250 may include rotating a hydrostatic quill in a second rotational direction with respect to the ball that is opposite the first rotational direction. For example, along a second side profile of the preform. As described above, steps 258 and 260 may include holding the finish cutting tool and/or the burnishing tool perpendicular to the surface of the preform and along the finish axis of rotation. Further step 260 may include dampening, with a vibrational damper, movements of the hydrostatic quill relative to the ball of the preform.

The process 250 may further include at step of moving a shaping module with a plurality of shaping tools affixed to the shaping module, relative to the preform for selective sequential engagement between the preform and the plurality of shaping tools. For example, the shaping module 26 may move the collection or gang of shaping tools 28A-28C or 128A-128D, which may occur during step 252. The process may further include a step of rotating the hydrostatic quill until a surface of the ball forms a layer with internal residual stress. In some embodiments, the entire process 300 (e.g., including idling, shaping, and finishing) may be completed within 45 seconds or less, 40 seconds or less, 38 seconds or less, 35 seconds or less, 30 seconds or less, 10 seconds or less, within 9 seconds or less, within 8 seconds or less, within 7 seconds or less, within 6 seconds or less, or within 5 seconds or less. As described above, the machine assembly 10, 110 may be scaled for producing several ball studs 300 simultaneously within the above timeframes, depending on the number of available machining stations 18, 118.

With reference now to FIG. 11, an example ball stud 300 is depicted in greater detail. The ball stud 300 may be formed via the machine assembly 10, 110 (e.g., via instructions from the control system 200) and/or the method or process 250. Generally, each material property described below may be obtainable by the machine assembly 10, 110 (e.g., via instructions from the control system 200) and/or the method or process 250. The ball stud 300 may include, similar to the preform 12, a stud portion 302 that extends to a head or ball 304. A collar portion 306 (e.g., or “undercut”) may be spaced between the stud portion 302 and the ball 304. The stud portion 302 may include outer threads, a hexagonal perimeter, tapers, and/or the like. The stud portion 302 may further include an internal cavity (not shown) which may include inner threads, hexagonal interior walls, and/or the like. The ball 304 may exhibit a surface roughness between about 0.1 Ra and about 0.01 Ra, between about 0.08 Ra and about 0.01 Ra, between about 0.06 Ra and about 0.01 Ra, between about 0.05 Ra and about 0.01 Ra, or about 0.05 Ra. Further, the ball 304 may include a microstructure layer having internal residual stress as a result of a hydrostatic burnishing. Generally speaking, the ball stud 300 may be configured to any number of applications including, but not limited to, implementation in a control arm of a vehicle, a robotic joint, and/or any joint between two or more components wherein multi-directional movement is beneficial. The ball stud 300 may have a radius or diameter between about 10 cm and 10 mm. In some implementations, the ball stud 300 may have a radius or diameter between about 10 mm and 15 mm.

With reference now to FIGS. 11 and 12, the stud portion 302 formed of a first material (“M₁”) and the ball 304 formed of the first material M₁ and extends from the stud portion 302. An outer shell 308 surrounds at least part of a surface 310 of the ball 304, the outer shell 308 is formed of a second material (“M₂”) with greater internal residual stress than the first material M₁. The ball stud 300 may be shaped in a machine assembly with one or more shaping stations and a finishing station. The steps associated with the machine assembly may occur, for example, after a near net shape cold forming step where a preform is initially formed and may be further modified via heat treatment. Cold forming can result in the ball stud 300 (e.g., and preform) that is harder, has improved yield, higher tensile strength, and a superior surface smoothness. The finishing station may include at least one burnishing quill that forms the outer shell 308. In some implementations, the at least one burnishing quill may be configured as a hydrostatic quill. As described herein, the ball stud 300 may be incorporated into a ball stud joint 400 that couples a first component 402 to a second component 404 and provides multi-directional movement between the first and second components 402, 404 (FIG. 3). Further, the first and second component 402, 404 may be configured as different assembly parts for incorporation into different structures 500A, 500B provided in FIGS. 14A and 14B.

With continued reference to FIGS. 11 and 12, the ball stud 300 may include a variety of shapes and dimensions based on end-use requirements. A central axis A_{c} may extend centrally through the ball stud 300 from a bottom stud side 311 to an upper ball side 312. The ball stud 300 may be generally symmetrical about the central axis A_{c}. A collar 306 (e.g., an undercut) may be located between the stud portion 302 and the ball 304. The collar 306 may include a groove extending inwardly towards the axis A_{c}, which may be annular in shape, conical in shape, or exhibit other profile shapes. The stud portion 302 may include a first tapered segment 314 that extends (e.g., conically) from the collar 306 (e.g., radially outwardly from the central axis A_{c}) to a second tapered segment 316. The second tapered segment 316 may extend (e.g., conically) from the first tapered segment 314 (e.g., radially inwardly towards the central axis A_{c}) to an engagement segment 318. The engagement segment 318 of the stud portion 302 may include one or more engagement profiles and/or structures to facilitate connection during installation. The one or more engagement profiles and/or structures may include treads, polygonal shapes (e.g., hexagonal), knurls, and/or the like.

As illustrated in FIG. 12, the stud portion 302 may include an internal cavity 319 that includes the one or more engagement profiles and/or structures in addition to or alternatively from the one or more engagement profiles and/or structures on an outer surface 320 of the stud 302 portion. However, it should be appreciated that other shapes, dimensions, and engagement profiles and/or structures may be utilized in the ball stud 300 other than those depicted in FIGS. 11 and 12. The outer shell 308 surrounds at least part of the surface 310 of the ball 304. For example, the outer shell 308 may surround substantially entirely the surface 310 of the ball 304 (e.g., from the collar 306 to the upper ball side 312). In some implementations, the outer shell 308 may surround a majority of the surface 310 of the ball 304, but terminate before and in a spaced relationship to the collar 306. Generally speaking, the outer shell 308 may surround a portion of the surface 310 of the ball 304 that is engaged during the multi-directional movement between the first and second components 402, 404 (FIG. 13).

In some implementations, the outer shell 308 may be formed of the first material M₁ that has been burnished. For example, the outer shell 308 may be formed of the first material M₁ that has been hydrostatically burnished. In other words, the outer shell 308 may be alternatively described as an outer layer of the ball 304 that has undergone a process of surface and microstructural changes to create a smooth exterior shell surface 322 with greater internal residual stress than the first material M₁. For example, the outer shell 308 may have a greater % by weight of austinite, pearlite, martensite, and/or bainite that the first material M₁ that has not undergone the microstructural change. The outer shell 308 may define a thickness “T” between the outer surface 310 of the ball 304 and the exterior shell surface 322. The thickness may be between one meter and one micrometer and may be uniform or non-uniform. The exterior shell surface 322 (i.e., the second material M₂) may exhibit a surface roughness that is less than 50% of an outer surface roughness of the first material M₁ (e.g., the outer surface of the ball stud 300 that is not surrounded in the outer shell 308). For example, the exterior shell surface 322 may exhibit a surface roughness that is less than 25%, less than 15%, less than 10%, or less than 5% of the surface roughness of the first material M₁. For example, the exterior shell surface 322 may exhibit a surface roughness less than 0.1 Ra, less than 0.09 Ra, less than 0.08 Ra, less than 0.07 Ra, less than 0.06 Ra, less than 0.05 Ra, or about 0.05 Ra. In some implementations, the first material M₁ may include steel or steel alloy.

With reference now to FIG. 13, a ball stud joint 400 that incorporates the ball stud 300 from FIGS. 11 and 12 is depicted. The ball stud joint 400 may include a first component 402 and a second component 404 and provide multi-directional movement between the first and second components 402, 404. The first component 402 may define a socket 406. The socket 406 may be sized to accommodate movement of the ball 304 during the multi-directional movement. The socket 406 may be formed of steel, steel alloy, or a different metal material. A friction reduction medium may be located in the socket 406 to reduce friction between the ball 304 and socket 406 during operational life. For example, the friction reduction medium may be an oil, a liquid, a solid such as nylon, combinations thereof, and/or the like. The second component 404 may be coupled to a ball stud 300 (e.g., via the engagement segment 318).

With reference now to FIGS. 14A and 14B, the ball stud joint 400 may be implemented in any environment or structure where it is beneficial to have a joint with multi-directional movement between components 402, 404. For example, in FIG. 4A a robotic arm 500A is illustrated that includes a plurality of arm segments 502. The arm segments 502 may be joined together by the ball stud joint 400 as described above in reference to the components 402, 404. In FIG. 4B, a component in a vehicle 500B is illustrated that incorporates the ball stud joint 400. While any joined components of the vehicle 500B may be coupled by the ball stud joint 400, FIG. 4B depicts a control arm 504 which may couple to the ball stud joint 400. More particularly, the control arm 504 may couple to the ball stud 300 and a steering knuckle 506 may include the socket 406, or vice versa.

The disclosure herein is further summarized in the following paragraphs and is further characterized by combinations of any and all of the various aspects described therein.

According to another aspect of the present disclosure, a machine assembly for shaping a ball stud. The machine includes a shaping workstation that has at least one shaping tool for removing material from and shaping a preform. A finish workstation includes a finish spindle configured to couple to and rotate the preform about a finish axis of rotation relative to a finish cutting module and a burnishing module. The finish cutting module includes a finish cutting tool and an actuator configured to move an edge of the finish cutting tool into engagement with a ball of the preform. The burnishing module includes a hydrostatic quill configured to contact and burnish an exterior surface of the ball.

According to yet another aspect, the finish cutting module includes a first rotational drive that rotates the finish cutting tool in a first rotational direction with respect to the ball.

According to still another aspect, the burnishing module includes a second rotational drive that rotates the hydrostatic quill in a second rotational direction with respect to the ball that is opposite the first rotational direction.

According to another aspect, the first and second rotational drives are configured to follow, with the hydrostatic quill, a surface of the ball that has already interfaced with the finish cutting tool.

According to yet another, the edge of the finish cutting tool is perpendicular to a surface of the ball.

According to still another aspect, the edge of the finish cutting tool is aligned with the finish axis of rotation.

According to another aspect, the finish cutting tool is a diamond shaped insert with a geometry between about 35° and about 55°.

According to yet another aspect, a vertically mounted robotic arm is configured to load the preform in the shaping workstation.

According to another aspect, a transfer arm is configured to move the preform from the shaping workstation to the finish workstation based on pivotal movement.

According to still another aspect, the shaping workstation includes a shaping spindle configured to couple to and rotate the preform along a shaping axis of rotation.

According to another aspect, the shaping workstation includes at least one shaping module that carries the at least one shaping tool transverse to the shaping axis of rotation for selective engagement with the preform.

According to yet another aspect, the at least one shaping tool includes at least two shaping tools and the at least one shaping module is configured to selectively bring one of the at least two shaping tools into contact with the preform.

According to still yet another aspect, at least one shaping module includes a first and second shaping module that are each configured to selectively bring different ones of the at least two shaping tools into contact with the preform.

According to still another aspect, the first and second shaping modules are each configured to selectively bring different ones of the at least two shaping tools into contact with the preform simultaneously.

According to still another aspect, the spindle is configured to rotate the preform between about 2,000 to about 6,000 RPMs.

According to another aspect, the hydrostatic quill includes a vibrational damper.

According to another aspect of the present disclosure, a machine assembly that forms a ball stud includes a finish spindle configured to couple to and rotate the preform about a finish axis of rotation, a finish cutting module, and a burnishing module. The finish cutting module includes a first rotational drive that rotates the finish cutting tool in a first rotational direction with respect to a ball of the preform. The burnishing module includes a second rotational drive that rotates a low plasticity burnishing quill in a second rotational direction with respect to the ball that is opposite the first rotational direction.

According to another aspect, the first and second rotational drives are configured to follow, with the low plasticity burnishing quill, a surface of the ball that has already interfaced with the cutting tool.

According to yet another aspect, an edge of the low plasticity burnishing quill is perpendicular to a surface of the ball.

According to still another aspect, the low plasticity burnishing quill is coupled to an inner shaft driven by the second rotational drive and the inner shaft is coupled to an outer sleeve.

According to another aspect, the inner shaft extends along an inner shaft axis and the outer sleeve extends along an outer sleeve axis that is parallel but misaligned with the inner shaft axis.

According to yet another aspect, the second rotational drive is configured to dampen vibrations via rotational hydrostatics.

According to yet another aspect of the present disclosure, a machine assembly for shaping a ball stud includes at least one arm configured load the preform into a workstation. The workstation includes a shaping workstation having at least two shaping tools selectively movable for simultaneous engagement with and removal of material from the preform. The machine assembly further includes a finish workstation having a finish cutting tool and a hydrostatic quill that is configured to follow surfaces of a ball of the preform that have already been engaged by the finish cutting tool.

According to yet another aspect, the at least one robotic arm is configured to load the preform into the shaping workstation and remove a shaped ball stud from the finish station upon completion in the finish station.

According to still another aspect, a timing between loading the preform into the shaping workstation and the completion of the ball stud at the finish station is less than or equal to 40 seconds.

According to still yet another aspect of the present disclosure, a process of shaping a ball stud includes shaping a preform at a shaping station, transferring the preform to a finish station, and rotating the preform about a finish axis of rotation. A finish cutting tool is rotated in a first rotational direction with respect to a ball of the preform, and a hydrostatic quill is rotated in a second rotational direction with respect to the ball that is opposite the first rotational direction.

According to yet another aspect, the process includes moving a shaping module with a plurality of shaping tools affixed to the shaping module, relative to the preform for selective sequential engagement between the preform and the plurality of shaping tools.

According to still another aspect, the process includes dampening, with a vibrational damper, movements of the hydrostatic quill relative to the ball of the preform.

According to still yet another aspect, the process includes rotating the finish cutting tool until a surface of the ball has a surface roughness less than 0.1 Ra.

According to yet another aspect, the process includes rotating the hydrostatic quill until a surface of the ball forms a layer with internal residual stress.

According to still another aspect, the process includes maintaining the finish cutting tool perpendicular to a surface of the ball.

According to one aspect of the present disclosure, a ball stud includes a stud portion formed of a first material and a ball formed of the first material and extending from the stud portion. An outer shell surrounds at least part of a surface of the ball, the outer shell formed of a second material with greater internal residual stress than the first material.

According to another aspect, the outer shell is the first material that has been burnished.

According to yet another aspect, the outer shell is the first material that has been hydrostatically burnished.

According to still another aspect, the outer shell has a greater % by weight of austinite than the first material.

According to another aspect, an outer surface of the second material exhibits a surface roughness that is less than 50% of an outer surface roughness of the first material.

According to yet another aspect, the outer surface of the second material exhibits a surface roughness that is less than 25% of the outer surface roughness of the first material.

According to still another aspect, the outer surface of the second material exhibits a surface roughness that is less than 15% of the outer surface roughness of the first material.

According to another aspect, the outer surface of the second material has a surface roughness less than 0.1 Ra.

According to yet another aspect, the outer surface of the second material has a surface roughness less than 0.06 Ra.

According to another aspect of the present disclosure, a ball stud includes a stud portion defining an outer stud portion surface and a ball with an outer shell defining an outer shell surface. The outer shell surface exhibits a surface roughness that is less than 25% of the outer stud portion surface.

According to yet another aspect, the outer shell surface exhibits a surface roughness that is less than 5% of the outer stud portion surface.

According to still another aspect, the ball stud portion and the ball are formed of a first material and the outer shell if formed of a second material with greater internal residual stress than the first material.

According to yet another aspect of the present disclosure, a ball stud joint includes a first component defining a socket and a second component coupled to a ball stud. The ball stud includes a stud portion and a ball seated within the socket. The ball has an outer shell defining an outer shell surface with a surface roughness less than 0.08 Ra.

According to still another aspect, the first component is a first segment of a robotic arm and the second component is a second segment of a robotic arm.

According to another aspect, the first component is a steering knuckle and the second component is a control arm.

According to yet another aspect, the ball stud joint is coupled to the second component by one of internal or external threads.

According to still another aspect, the ball stud portion and the ball are formed of a first material and the outer shell if formed of a second material with greater internal residual stress than the first material.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A machine assembly for shaping a ball stud, comprising:
a shaping workstation including at least one shaping tool for removing material from and shaping a preform; and
a finish workstation comprising;
a finish spindle configured to couple to and rotate the preform about a finish axis of rotation;
a finish cutting module including a finish cutting tool and an actuator configured to move an edge of the finish cutting tool into engagement with a ball of the preform; and
a burnishing module including a hydrostatic quill configured to contact and burnish an exterior surface of the ball.

2. The machine assembly of claim 1, wherein the finish cutting module includes a first rotational drive that rotates the finish cutting tool in a first rotational direction with respect to the ball.

3. The machine assembly of claim 2, wherein the burnishing module includes a second rotational drive that rotates the hydrostatic quill in a second rotational direction with respect to the ball that is opposite the first rotational direction.

4. The machine assembly of claim 3, wherein the first and second rotational drives are configured to follow, with the hydrostatic quill, a surface of the ball that has already interfaced with the finish cutting tool.

5. The machine assembly of claim 1, wherein the edge of the finish cutting tool is perpendicular to a surface of the ball.

6. The machine assembly of claim 5, wherein the edge of the finish cutting tool is aligned with the finish axis of rotation.

7. The machine assembly of claim 1, wherein the finish cutting tool is a diamond shaped insert with a geometry between about 35° and about 55°.

8. The machine assembly of claim 1, wherein a transfer arm is configured to move the preform from the shaping workstation to the finish workstation based on pivotal movement.

9. The machine assembly of claim 1, wherein the shaping workstation includes a shaping spindle configured to couple to and rotate the preform along a shaping axis of rotation.

10. The machine assembly of claim 9, wherein the shaping workstation includes at least one shaping module that carries the at least one shaping tool transverse to the shaping axis of rotation for selective engagement with the preform.

11. The machine assembly of claim 10, wherein the at least one shaping tool includes at least two shaping tools and the at least one shaping module is configured to selectively bring one of the at least two shaping tools into contact with the preform.

12. The machine assembly of claim 11, wherein the at least one shaping module includes a first and second shaping module that are each configured to selectively bring different ones of the at least two shaping tools into contact with the preform.

13. The machine assembly of claim 12, wherein the first and second shaping modules are each configured to selectively bring different ones of the at least two shaping tools into contact with the preform simultaneously.

14. A machine assembly that forms a ball stud, the machine assembly comprising:
a finish spindle configured to couple and rotate a preform about a finish axis of rotation;
a finish cutting module including a first rotational drive that rotates a finish cutting tool in a first rotational direction with respect to a ball of a preform; and
a burnishing module including a second rotational drive that rotates a low plasticity burnishing quill in a second rotational direction with respect to the ball that is opposite the first rotational direction.

15. The machine assembly of claim 14, wherein the first and second rotational drives are configured to follow, with the low plasticity burnishing quill, a surface of the ball that has already interfaced with the cutting tool.

16. The machine assembly of claim 14, wherein the low plasticity burnishing quill is coupled to an inner shaft driven by the second rotational drive and the inner shaft is coupled to an outer sleeve.

17. The machine assembly of claim 16, wherein the inner shaft extends along an inner shaft axis and the outer sleeve extends along an outer sleeve axis that is parallel but misaligned with the inner shaft axis.

18. The machine assembly of claim 14, wherein the second rotational drive is configured to dampen vibrations via rotational hydrostatics.

19. A machine assembly for shaping a ball stud, comprising:
at least one arm configured to load a preform into a workstation; and
the workstation including a shaping workstation having at least two shaping tools selectively movable for simultaneous engagement with and removal of material from the preform, and a finish workstation having a finish cutting tool and a hydrostatic quill that is configured to follow surfaces of a ball of the preform that have already been engaged by the finish cutting tool.

20. The machine assembly of claim 19, wherein a timing between loading the preform into the shaping workstation and the completion of the ball stud at the finish station is less than or equal to 40 seconds.
